(19) United States
(12) Patent Application Publication
(10) Pub. No.: US 2016/0335986 A1
(43) Pub. Date: Nov. 17, 2016

(54) ELECTRONIC DEVICE, DRIVER FOR DISPLAY DEVICE, COMMUNICATION DEVICE INCLUDING THE DRIVER, AND DISPLAY SYSTEM

(71) Applicant: SAMSUNG ELECTRONICS CO., LTD., Gyeonggi-do (KR)

(72) Inventors: Jong-kon BAE, Seoul (KR); Yong-man LEE, Gyeonggi-do (KR); Kwang-young KIM, Gyeonggi-do (KR); Jae-hun CHO, Gyeonggi-do (KR); Jae-won CHOI, Gyeonggi-do (KR); Dong-kyoon HAN, Gyeonggi-do (KR)

(21) Appl. No.: 15/110,583

(22) PCT Filed: Jan. 14, 2015
(86) PCT No.: PCT/KR2015/000397

§ 371 Date: Jul. 8, 2016

(30) Foreign Application Priority Data
Jan. 14, 2014 (KR) 10-2014-0004691

(51) Int. Cl. G09G 5/02; G09G 5/00; G09G 5/373

(52) U.S. Cl. CPC G09G 5/02; G09G 5/373; G09G 5/005; G09G 2300/0452; G09G 2320/0613; G09G 2340/06; G09G 2340/0407; G09G 2330/021; G09G 2350/00

(57) ABSTRACT

An electronic device includes an application processor that generates conversion data by downsizing display data of each frame according to display characteristic information of each frame; and a display driver that receives the conversion data and the display characteristic information and drives a display panel in response to received conversion data and display characteristic information.

### TECHNICAL FIELD

One or more embodiments of the present invention relate to an electronic device, a driver for a display device, a communication device including the driver, and a display system, and more particularly, to an electronic device, a driver for a display device, a communication device including the driver, and a display system, all of which are driven with low power.

### BACKGROUND ART

Recently, as smart phones and tablet personal computers (PCs) including display modules having super resolution of a high resolution television (HDTV) level, mobile displays have been manufactured to have a resolution of a wide video graphics array (WVGA) level or a full HD level.

In this case, since driver in a display device processes an increased amount of data, a current amount used by the driver has gradually increased. For example, a data throughput of a flat panel display device has increased due to an increase of a frame rate and a resolution of the flat panel display device.

### DISCLOSURE OF INVENTION

### Solution to Problem

One or more embodiments of the present invention include electronic device, a driver for a display device, a communication device including the driver, and a display device, whereby a display data transmission amount is reduced when transmitting display data as a data transmission device (for example, a processor or an electronic device) and a data reception device (for example, a display device or another electronic device) are connected to each other, and are capable of reducing current consumption or data throughput of each of a display data transmission device (for example, a processor or an electronic device) and a display data reception device (for example, a display device or another electronic device).

### Advantageous Effects of Invention

In the electronic device 100 according to one or more embodiments of the present invention, the AP 110 transmits a relatively small amount of data to the DDI 120, and thus, power consumed to transmit data from the AP 110 to the DDI 120 or from the electronic device 100 to another electronic device may be reduced.

An electronic device (for example, a display device, an electronic device having a communication function, or a display system), according to one or more embodiments, is capable of reducing a display data transmission amount while transmitting display data as a data transmission device (for example, a processor or an electronic device) and a data reception device (for example, a display unit or another electronic device) are connected to each other, and is also capable of reducing current consumption of each of a display data transmission device (for example, a processor or an electronic device) and a display data reception device (for example, a display unit or another electronic device).

### BRIEF DESCRIPTION OF DRAWINGS

FIG. 1 is a block diagram of a electronic device according to an embodiment of the present invention;

FIG. 2 is a flowchart of operations of a electronic device, according to an embodiment of the present invention;

FIG. 3 is a block diagram of a electronic device according to another embodiment of the present invention;

FIGS. 4A through 4E are diagrams of scalers for replacing that of FIG. 3;

FIG. 5 is timing diagrams for describing display driving signals according to embodiments of the present invention;

FIG. 6 is a block diagram of a electronic device according to another embodiment of the present invention;

FIG. 7 is a block diagram of a electronic device according to another embodiment of the present invention;

FIG. 8 is a block diagram of a electronic device according to another embodiment of the present invention;

FIG. 9 is a block diagram of a electronic device according to another embodiment of the present invention;

FIG. 10 is a block diagram of a electronic device according to another embodiment of the present invention;

FIG. 11A is a diagram for describing a method of sampling a pixel group corresponding to each frame, the method being performed in a circular sampler of the electronic device of FIG. 10;

FIG. 11B through 11D are diagrams for describing methods of updating a pixel group corresponding to each frame, the methods being performed by a logic circuit of a electronic device;

FIG. 12 is a block diagram of a electronic device according to another embodiment of the present invention;

FIG. 13 illustrates various patterns of sub-pixels in one pixel included in display panels, according to embodiments of the present invention;

FIG. 14 is a diagram of a stacked structure of sub-pixels in one pixel included in display panels according to embodiments of the present invention;

FIG. 15 is a diagram of a display module according to an embodiment of the present invention;

FIG. 16 is a block diagram of a display system according to an embodiment of the present invention;

FIG. 17 is a block diagram of a display system according to another embodiment of the present invention;

FIG. 18 is a block diagram of a mobile electronic device related to one or more embodiments of the present invention; and

FIG. 19 shows application examples of various electronic products including a electronic device, according to embodiments of the present invention.

### BEST MODE FOR CARRYING OUT THE INVENTION

Additional aspects will be set forth in part in the description which follows and, in part, will be apparent from the description, or may be learned by practice of the presented embodiments.

According to one or more embodiments of the present invention, an electronic device includes: an application processor configured to generate conversion data by downsizing display data of each frame of according to display characteristic information of the each frame; and a display driver configured to receive the conversion data and the display characteristic information and drive a display panel in response to the conversion data and the display characteristic information.

According to one or more embodiments of the present invention, an electronic device includes: a data driver configured to supply to each of a plurality of unit pixels included in a display panel a voltage signal corresponding to display data; and a timing controller configured to control driving of the data driver, receive downsized data obtained by downsizing display data of each frame from an application processor, generate upsized data by upsizing the downsized data, and supply the upsized data to the data driver.

According to one or more embodiments of the present invention, a display system includes: a first electronic device configured to generate conversion data by downsizing display data of each frame according to display characteristic information of the each frame; and a second electronic device configured to receive the conversion data and the display characteristic information and drives a display panel in response to the received conversion data and the display characteristic information.

### MODE FOR THE INVENTION

Hereinafter, one or more embodiments of the present invention will be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art. In the drawings, like reference numerals denote like elements, and the sizes and thicknesses of layers and regions are exaggerated for clarity.

The terms used in the present specification are merely used to describe particular embodiments, and are not intended to limit the present invention. An expression used in the singular encompasses the expression of the plural, unless it has a clearly different meaning in the context. In the present specification, it is to be understood that the terms such as “include”, “may include” or “have”, etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

While such terms as “first”, “second”, etc., may be used to describe various components, such components must not be limited to the above terms. The above terms are used only to distinguish one component from another. For example, a first component may be referred to as a second component, and similarly, a second component may be referred to as a first component without departing from the scope of the invention.

Unless otherwise defined, all terms including technical and scientific terms used herein have the same meaning as commonly understood by one of ordinary skill in the art to which this invention belongs. It will be further understood that terms, such as those defined in commonly used dictionaries, should be interpreted as having a meanings that are consistent with their meanings in the context of the relevant art and will not be interpreted in an idealized or overly formal sense unless expressly so defined herein.

As used herein, the term “and/or” includes any and all combinations of one or more of the associated listed items. Expressions such as “at least one of,” when preceding a list of elements, modify the entire list of elements and do not modify the individual elements of the list.

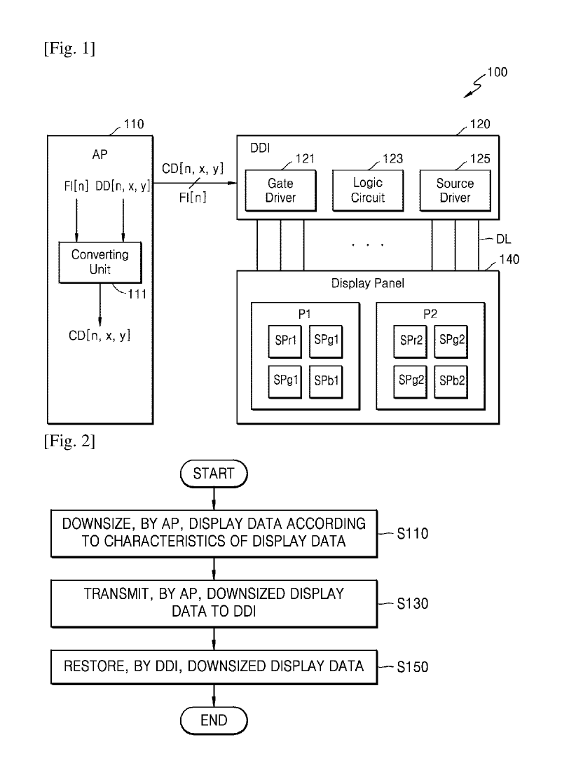

FIG. 1 is a block diagram of an electronic device 100 according to an embodiment of the present invention.

Referring to FIG. 1, the electronic device 100 may have a display function or various communication functions. For example, the electronic device 100 may be a laptop computer, a mobile phone, a smart phone, a tablet personal computer (PC), a personal digital assistant (PDA), an enterprise digital assistant (EDA), a digital still camera, a digital video camera, a portable multimedia player (PMP), a personal navigation device or portable navigation device (PND), a handheld game console, a mobile internet device (MID), an e-book, etc.

The electronic device 100 may include an application processor (AP) 110, a display driver integrated circuit (IC) (DDI) 120, and a display panel 140.

The AP 110 may include at least one AP or at least one communication processor (CP) (not shown).

For example, the AP 110 and the CP may be included in one IC package or in different IC packages.

The AP 110 may drive an operating system or an application program to control a plurality of hardware or software components connected to the AP 110, and may perform various data processes and operations with regard to multimedia data. The AP 110 may be, for example, a system-on-chip (SoC). According to an embodiment, the AP 110 may further include a graphic processing unit (GPU) (not shown).

If the electronic device 100 includes a communication function, the AP 110 may perform local area communication, determine its location information, receive a broadcast, wirelessly access the Internet, and recognize a user input.

According to one or more embodiments of the present invention, the AP 110 may include a converting unit 111. The converting unit 111 may receive display characteristic information FI[n] of each frame, and display data DD[n,x,y], wherein n denotes a frame number, and x and y denote pixel address values.

According to one or more embodiments of the present invention, the display characteristic information FI[n] may be information about characteristics of display data. For example, the display characteristic information FI[n] may include information about how much display data is compressible, information about various formats for displaying display data (for example, a cell array size, image resolution, and a subpixel pattern), information about similarity of display data between a previous frame and a current frame, or information about how often one color is repeated in a certain section.

For example, the display characteristic information FI[n] of each frame may include a binary signal for determining compression of the display data DD[n,x,y]. The display characteristic information FI[n] of each frame may be obtained from the display data DD[n,x,y] of the corresponding frame. In the present specification, compressing data means that a size of the data is reduced and this term may be used interchangeably with data downsizing.

The converting unit 111 may receive the display characteristic information FI[n] of each frame and the display data DD[n,x,y], and generate conversion data CD[n,x,y] by downsizing the display data DD[n,x,y] according to the display characteristic information FI[n] of each frame.

For example, if display data DD[k] can be downsized with high compressibility, for example, at least 30%, display characteristic information FI[k] of a corresponding frame may be, for example, 1. If the display characteristic information FI[k] is 1, the converting unit 111 may generate conversion data CD[k] by downsizing the display data DD[k].

For example, if display data DD[k] can be downsized with low compressibility, for example, lower than or equal to 60%, display characteristic information FI[k] of a corresponding frame may be, for example, 0. If the display characteristic information FI[k] is 0, the converting unit 111 may generate conversion data CD[k] that is the same as the display data DD[k] without downsizing the display data DD[k].

The converting unit 111 may use various methods to downsize the display data DD[k].

For example, the converting unit 111 may compress display data of a plurality of adjacent pixels to display data of one pixel. Alternatively, for example, the converting unit 111 may convert first sub-pixel pattern information corresponding to display data to second sub-pixel pattern information. Alternatively, for example, the converting unit 111 may sample only pixels in any one of a plurality of pixel groups included in a pixel group including a plurality of pixels.

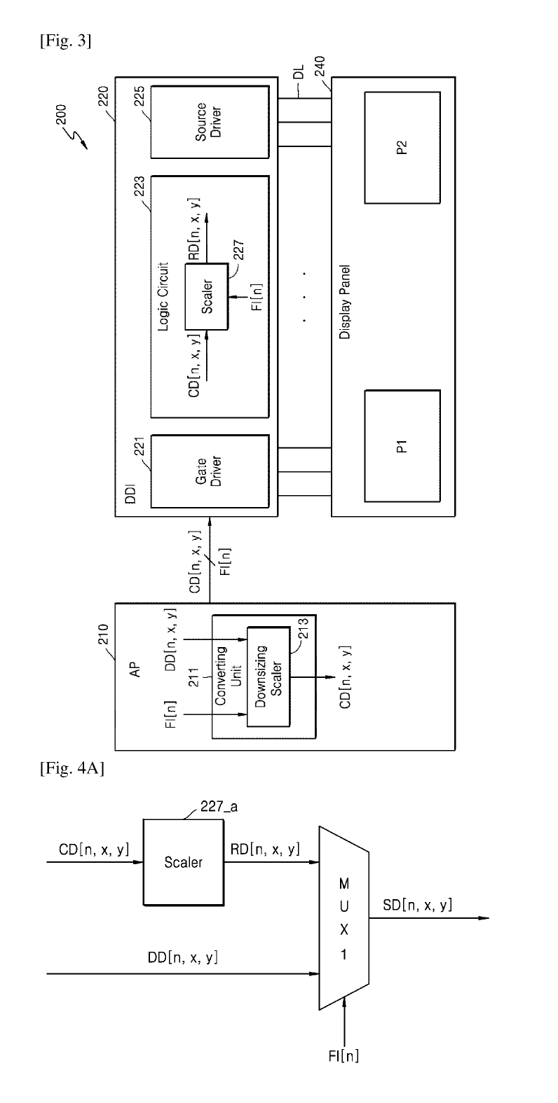

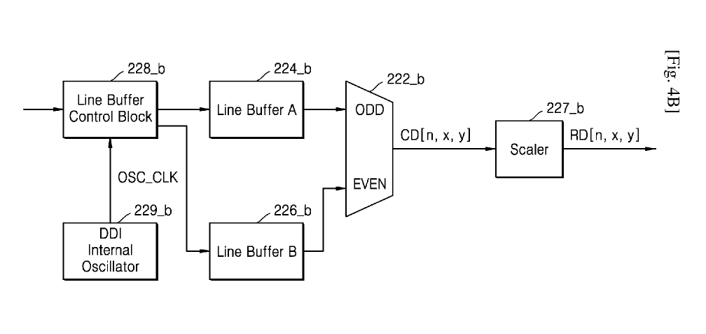

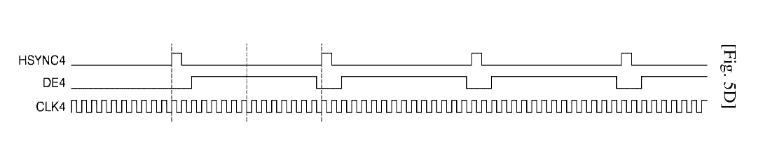

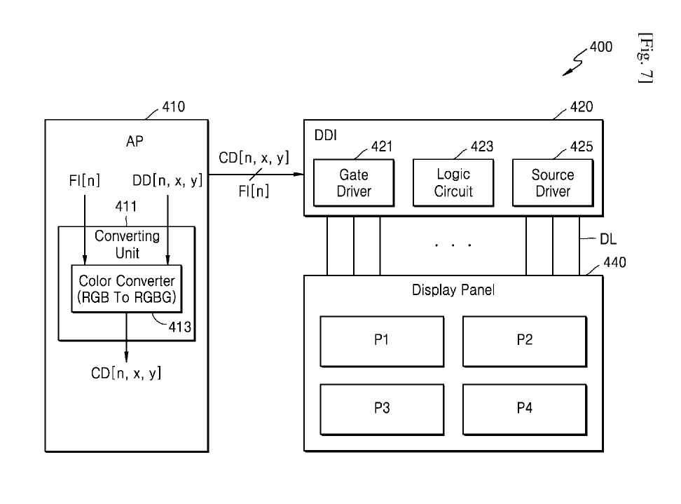

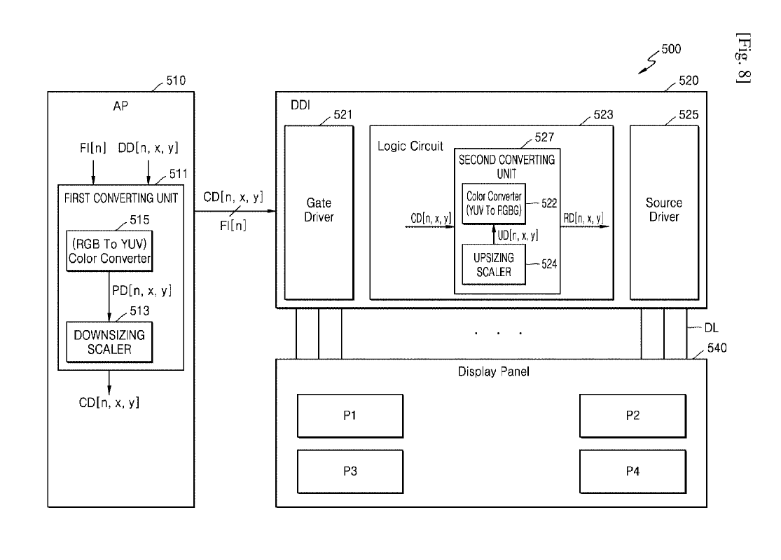

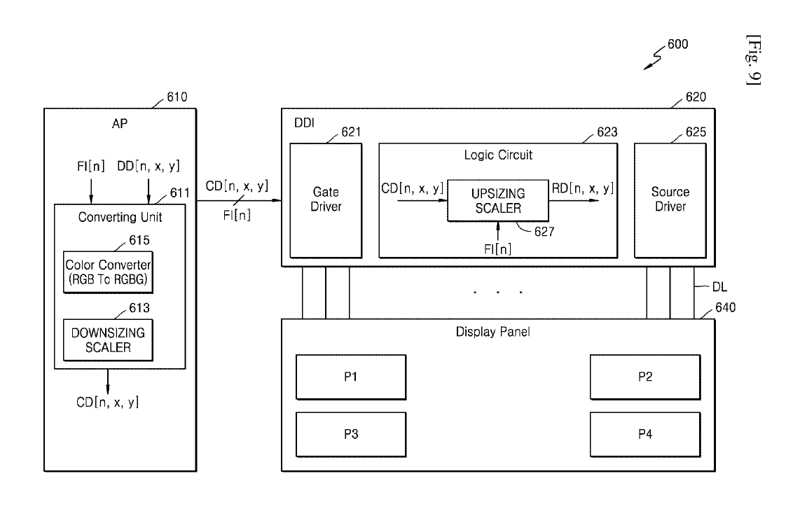

Details about such examples will be described in detail later with reference to FIGS. 3 through 10. For example, the converting unit 111 may include a downsizing scaler 213 shown in FIG. 3, a color converter 313 shown in FIG. 6 or a color convertor 413 shown in 7, a first converting unit 511 shown in FIG. 8, a converting unit 611 shown in FIG. 9, a circular sampler 713 shown in FIG. 10, or some or all of these element.

The DDI 120 may include a gate driver 121, a logic circuit 123, and a source driver 125.

One gate driver 121 and one source driver 125 are shown as an example in FIG. 1, but the numbers of gate drivers 121 and source drivers 125 may vary according to embodiments.

Also, in FIG. 1, the DDI 120 and the AP 110 are included in the electronic device 100. However, according to another embodiment, the DDI 120 may be included in an electronic device different from the electronic device 100 including the AP 110.

The logic circuit 123 may generate, based on timing signals, a data control signal for controlling an operation timing of the source driver 125 and a gate control signal for controlling an operation timing of the gate driver 121, such as a horizontal synchronization signal, a vertical synchronization signal, a clock signal, and a data enable signal. According to one or more embodiments of the present invention, the logic circuit 123 may receive and upsize downsized display data, and transmit the upsized display data to the source driver 125. According to one or more embodiments of the present invention, the logic circuit 123 may receive a display signal from an internal memory of the DDI 120 to control the source driver 125 and the gate driver 121.

The gate driver 121 may select a horizontal line to which a voltage signal is to be applied by generating and sequentially applying a scan pulse to gate lines GL under control of the logic circuit 123. The source driver 125 may transmit voltage signals corresponding to display data to the display panel 140 through data lines DL in response to, for example, gamma voltages output from a gamma circuit.

For example, since the source driver 125 and the gate driver 121 are capable of controlling operations of pixels of the display panel 140, the electronic device 100 may display an image corresponding to the display data transmitted by the AP 110 through the display panel 140.

The display panel 140 may include a thin-film transistor-liquid crystal display (TFT-LCD), a light-emitting diode (LED) display, an organic LED (OLED) display, an active-matrix OLED (AMOLED) display, a flexible display, or any other type of flat-panel display. The display panel 140 may be, for example, flexible, transparent, or wearable. The display panel 140 may be integrated with a touch panel to form one module.

A hologram unit that realizes a stereoscopic image in the air by using interference of light may be used instead of the display panel 140. Also, a projector that displays an image by projecting light on a screen may be used instead of the display panel 140. The screen may be located inside or outside the electronic device 100.

As shown in FIG. 1, a plurality of pixels, for example, first and second pixels P1 and P2, included in the display panel 140 may each have a PenTile structure including one red sub-pixel, one blue sub-pixel, and two green sub-pixels. The plurality of pixels included in the display panel 140 may each include at least one of red, green, blue, and white sub-pixels. The plurality of pixels included in the display panel 140 may have any one of various configurations and shapes according to embodiments.

For example, to drive the display panel 140, the DDI 120 upsizes the conversion data CD[n,x,y] according to the display characteristic information FI[n].

For example, the display characteristic information FI[n] may be a binary signal determined by referring to size of data compressible in the display data DD[n,x,y].

For example, the downsizing may be performed by compressing display data of a plurality of adjacent pixels to display data of one pixel.

For example, the downsizing may be performed by converting first sub-pixel pattern information corresponding to the display data DD[n,x,y] to second sub-pixel pattern information.

For example, the first sub-pixel pattern information may be sub-pixel pattern information of a red, green, and blue (RGB) pattern including three sub-pixels in one pixel, and the second sub-pixel pattern information may be sub-pixel pattern information of a pentile (RGBG) pattern including two sub-pixels in one pixel.

For example, the first sub-pixel pattern information may be sub-pixel pattern information of an RGB pattern including three sub-pixels in one pixel, and the second sub-pixel pattern information may be sub-pixel pattern information of a YUV pattern including three sub-pixels in one pixel.

For example, to drive the display panel 140, the DDI 120 may upsize the conversion data CD[n,x,y] according to the display characteristic information FI[n], the upsizing being performed by converting second sub-pixel pattern information corresponding to the display data DD[n,x,y] to third sub-pixel pattern information. In this case, the third sub-pixel pattern information may be sub-pixel pattern information of a PenTile (RGBG) pattern including two sub-pixels in one pixel.

For example, the downsizing may be performed by generating first compression display data by compressing display data of a plurality of adjacent pixels to display data of one pixel, and converting first sub-pixel pattern information corresponding to the first compression display data to second sub-pixel pattern information.

For example, the first sub-pixel pattern information may be sub-pixel pattern information of an RGB pattern including three sub-pixels in one pixel, and the second sub-pixel pattern information may be sub-pixel pattern information of a pentile (RGBG) pattern including two sub-pixels in one pixel.

For example, the first sub-pixel pattern information may be sub-pixel pattern information of an RGB pattern including three sub-pixels in one pixel, and the second sub-pixel pattern information may be sub-pixel pattern information of an YUV pattern including three sub-pixels in one pixel.

For example, to drive the display panel 140, the DDI 120 may upsize the conversion data CD[n,x,y] according to the display characteristic information FI[n], the upsizing being performed by converting second sub-pixel pattern information corresponding to the display data DD[n,x,y] to third sub-pixel pattern information. In this case, the third sub-pixel pattern information may be sub-pixel pattern information of a PenTile (RGBG) pattern including two sub-pixels in one pixel.

For example, the downsizing may be performed by sampling only pixels corresponding to a first pixel group from among a plurality of pixel groups included in a pixel block including a plurality of pixels.

For example, the plurality of pixel groups may include first and second pixel groups, wherein the first pixel group includes pixels connected to odd row lines and the second pixel group includes pixels connected to even row lines.

For example, the DDI 120 may update only display data about the first or second pixel group to the display panel 140 according to each frame.

For example, the plurality of pixel groups may include first and second pixel groups, wherein the first pixel group includes pixels connected to odd column lines and the second pixel group includes pixels connected to even column lines.

For example, the DDI 120 may update only display data about the first or second pixel group to the display panel 140 according to each frame.

For example, the plurality of pixel groups may include first through fourth pixel groups, wherein the first pixel group includes pixels connected to odd row lines and odd column lines, the second pixel group includes pixels connected to the odd row liens and even column lines, the third pixel group include pixels connected to even row lines and the odd column lines, and the fourth pixel group includes pixels connected to the even row lines and the even-th column lines.

For example, the DDI 120 may update only display data about one of the first through fourth pixel groups to the display panel 140 according to each frame.

An electronic device having a communication function, according to another embodiment of the present invention, may include: an AP that obtains conversion data by downsizing display data of each frame of according to display characteristic information of the each frame; and a display driver that receives the conversion data and the display characteristics information of the each frame and drives a display panel according to the received conversion data and display characteristic information.

In the electronic device 100 according to one or more embodiments of the present invention, the AP 110 transmits a relatively small amount of data to the DDI 120, and thus, power consumed to transmit data from the AP 110 to the DDI 120 or from the electronic device 100 to another electronic device may be reduced.

An electronic device (for example, a display device, an electronic device having a communication function, or a display system), according to one or more embodiments, is capable of reducing a display data transmission amount while transmitting display data as a data transmission device (for example, a processor or an electronic device) and a data reception device (for example, a display unit or another electronic device) are connected to each other, and is also capable of reducing current consumption of each of a display data transmission device (for example, a processor or an electronic device) and a display data reception device (for example, a display unit or another electronic device).

FIG. 2 is a flowchart of operations of the electronic device 100, according to an embodiment of the present invention.

Referring to FIG. 2, in operation S 110, according to an embodiment, the AP 110 may downsize display data according to characteristics of the display data. For example, the converting unit 111 of the AP 110 may receive the display characteristic information FI[n] of each frame and the display data DD[n,x,y], and generate the conversion data CD[n,x,y] by downsizing the display data DD[n,x,y].

In operation S 130, according to an embodiment, the AP 110 may transmit the downsized display data to the DDI 120. For example, the AP 110 may reduce a data amount transmitted from the AP 110 to the DDI 120, and may reduce power consumed by the electronic device 100 or another electronic device.

In operation S 150, according to an embodiment, the DDI 120 may receive and restore the conversion data CD[n,x,y] to drive the display panel 140.

FIG. 3 is a block diagram of an electronic device 200 according to another embodiment of the present invention.

Referring to FIG. 3, the electronic device 200 may include an AP 210, a DDI 220, and a display panel 240.

The AP 210 of the electronic device 200 according to one or more embodiments of the present invention may include a converting unit 211. The converting unit 211 may include a downsizing scaler 213. According to an embodiment, the AP 210 of FIG. 3 may be the AP 110 of FIG. 1. According to an embodiment, the converting unit 211 of FIG. 3 may be the converting unit 111 of FIG. 1.

The term scaler used in the present specification may mean a circuit that adjusts the number of pixels for displaying an object. For example, a downsizing scaler may be a circuit that reduces the number of pixels for displaying the same object, and an upsizing scaler may be a circuit that increases the number of pixels for displaying the same object.

The downsizing scaler 213 may receive display characteristic information FI[n] of each frame and display data DD[n,x,y], wherein n denotes a frame number, and x and y denote pixel address values.

The downsizing scaler 213 may generate conversion data CD[n,x,y] by receiving the display characteristic information FI[n] of each frame and the display data DD[n,x,y].

For example, the downsizing scaler 213 may compress display data of a plurality of adjacent pixels to display data of one pixel. For example, the downsizing scaler 213 may downsize a signal about a 1000×2000 pixel array to a signal about a 500×1000 pixel array.

For example, display data of a 2×2 pixel group that is a part of a 1000×2000 pixel array of a first frame may be assumed to be as presented below. Here, it is assumed that color data A2, A3, and A4 have similar values as color data around respective pixels. Such similarity is included in display characteristic information FI[1] of the first frame.

DD[n:1, x:100, y:100]=A1

DD[n:1, x:101, y:100]=A2

DD[n:1, x:100, y:101]=A3

DD[n:1, x:101, y:101]=A4

The downsizing scaler 213 may calculate display data corresponding to a 500×1000 pixel array as follows.

CD[n:1, x:50, y:50]=A1

The AP 210 may transmit conversion data calculated as such, for example, CD[n:1, x:50, y:50]=A1, to the DDI 220. The DDI 220 may receive and transmit the conversion data CD[n:1, x:50, y:50] to a logic circuit 223. Accordingly, the AP 210 transmits one of four pieces of data to the DDI 220, and thus power consumption of the electronic device 200 may be reduced.

The display driver 220 may include a gate driver 221, the logic circuit 223, and a source driver 225.

The gate driver 221, the source driver 225, and the display panel 240 of FIG. 3 may operate similarly to the gate driver 121, the source driver 125, and the display panel 140 of FIG. 1, and thus details thereof are not repeated here.

The logic circuit 223 according to one or more embodiments of the present invention may include a scaler 227. The scaler 227 may receive conversion data CD[n,x,y], and upsize or downsize the conversion data CD[n,x,y] according to a structure of the display panel 240.

For example, the scaler 227 may receive display characteristic information FI[n] of each frame and conversion data CD[n,x,y]. The scaler 227 may generate recovery data RD[n,x,y] by using the conversion data CD[n,x,y] according to the display characteristic information FI[n] of each frame.

In the above example, it may be assumed that following data is received from among conversion data corresponding to a 500×1000 pixel array of a first frame.

DD[n:1, x:50, y:50]=A1

The scaler 227 may calculate display data of 2×2 pixel groups of a 1000×2000 pixel array of the first frame by using the above data.

DD[n:1, x:100, y:100]=A1

DD[n:1, x:101, y:100]=A1

DD[n:1, x:100, y:101]=A1

DD[n:1, x:101, y:101]=A1

The source driver 225 may receive and supply restored display data to the display panel 240.

However, the above descriptions do not limit the scope of the invention, and a downsizing rate or numbers of horizontal and vertical pixels in a pixel array may vary according to embodiments.

Since it is assumed that the color data A2, A3, and A4 have values similar to the color data around the respective pixels, a user is unable to identify a difference between an original object and a restored object with the naked eyes. Thus, an actual shape of an object recognized by the user may not change.

In the electronic device 200 according to one or more embodiments of the present invention, the AP 210 transmits a relatively small amount of data to the DDI 220, and thus power consumed to transmit data from the AP 210 to the DDI 220 or from the electronic device 200 to another electronic device may be reduced.

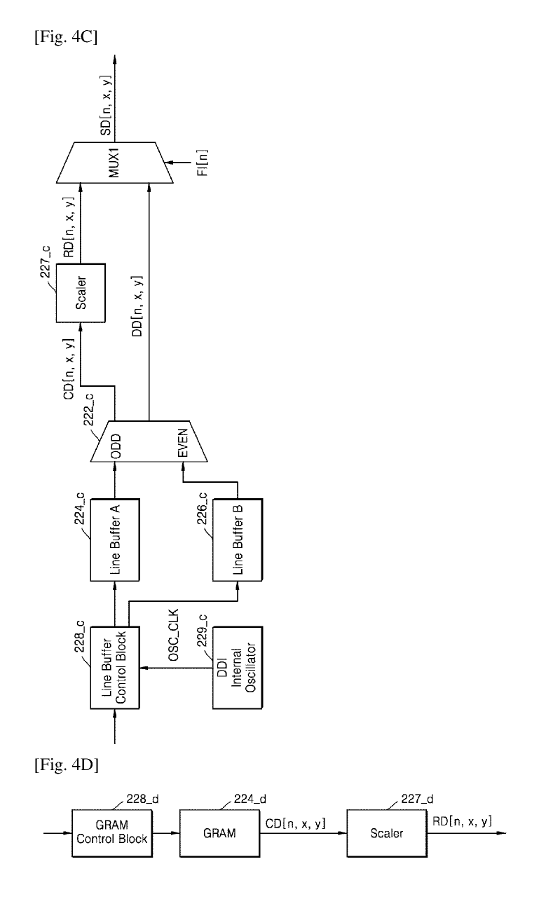

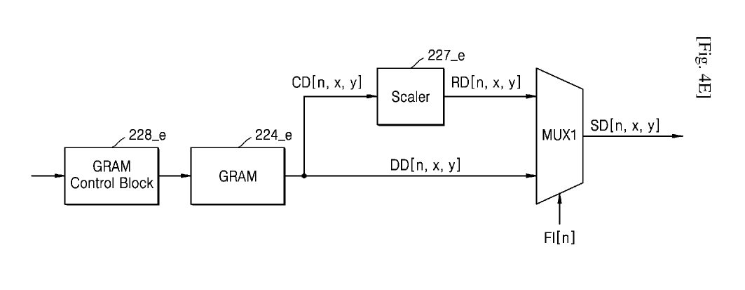

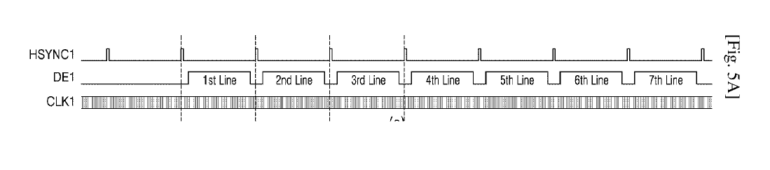

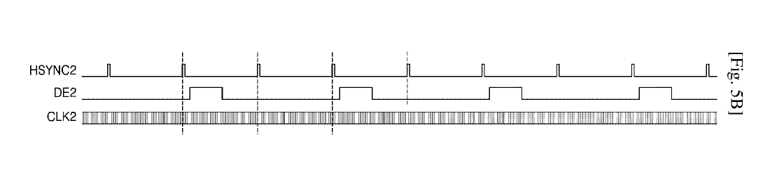

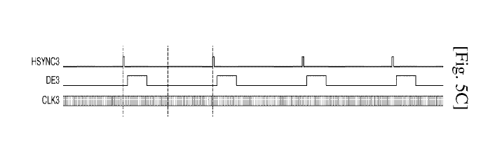

FIGS. 4A through 4E are diagrams of scalers 227_a through 227_e for replacing the scaler 227 of FIG. 3.

Referring to FIG. 4A, the scaler 227_a may generate recovery data RD[n,x,y] by receiving conversion data CD[n,x,y]. The logic circuit 223 may transmit the recovery data RD[n,x,y] and display data DD[n,x,y] to a first multiplexer MUX1. The first multiplexer MUX1 may generate selection data SDD[n,x,y] by selecting one of the recovery data RD[n,x,y] and the display data DD[n,x,y] according to display characteristic information FI[n] of each frame.

The electronic device 200 according to the current embodiment may transmit the display data DD[n,x,y] that is bypassed to the source driver 225 of FIG. 3, according to the display characteristic information FI[n] of each frame.

For example, if content of the display characteristic information FI[n] of a respective frame shows that a displayed object has a simple structure, the logic circuit 223 may transmit the recovery data RD[n,x,y] to the source driver 225. In this case, the AP 210 of FIG. 3 may have low power consumption since the display data DD[n,x,y] is reduced and transmitted to the DDI 220 of FIG. 3.

For example, if content of the display characteristic information FI[n] of a respective frame shows that a displayed object has a complex structure, the logic circuit 223 may transmit the display data DD[n,x,y] to the source driver 225. In this case, the DDI 220 of FIG. 3 receives the display data DD[n,x,y], and thus the displayed object may be shown in more detail.

Referring to FIG. 4B, the scaler 227_b may generate recovery data RD[n,x,y] by receiving conversion data CD[n,x,y]. A data merger 222_b may output the conversion data CD[n,x,y] by selecting one of a line buffer A 224_b and a line buffer B 226_b according to a frequency setting.

For example, a line buffer control block 228_b may output first display data and second display data.

For example, the line buffer control block 228_b may output the first display data corresponding to odd lines and the second display data corresponding to even lines, each in data units of 4 pixels, from among display data input from a mobile industry processor interface (MIPI) wrapper (not shown). For example, the line buffer control block 228_b receives display data in data units of 2 pixels, and output display data in data units of 4 pixels.

Also, the line buffer A 224_b may receive the first display data of the odd lines in response to an external clock, and output the first display data in response to an internal clock. Also, the line buffer B 226_b may receive the second display data of the even lines in response to an external clock, and output the second display data in response to an internal clock.

A frequency of an internal clock may be slower than that of an external clock. A DDI internal oscillator 229_b may generate an internal clock OSC_CLK to be used by a DDI.

The electronic device 200 according to the current embodiment is capable of scaling a signal received from a line buffer, and may process display data with low power by using the line buffer.

The scaler 227_c of FIG. 4C is obtained by combining distinctive features of FIGS. 4A and 4B. Referring to FIG. 4C, for example, the scaler 227_c may generate recovery data RD[n,x,y] by receiving conversion data CD[n,x,y]. The recovery data RD[n,x,y] and display data DD[n,x,y] may be transmitted to the first multiplexer MUX1. The first multiplexer MUX1 may generate selection data SD[n,x,y] by selecting one of the recovery data RD[n,x,y] and the display data DD[n,x,y] according to display characteristic information FI[n] of each frame.

Also, a data merger 222_c may output the conversion data CD[n,x,y] by selecting one of a line buffer A 224_c or a line buffer B 226_c according to a frequency setting. Operations of the line buffer A 224_c and the line buffer B 226_c may be similar to those of the line buffer A 224_b and the line buffer B 226_b.

Accordingly, since the electronic device 200 according to the current embodiment uses a line buffer and transmits the display data DD[n,x,y] that is bypassed to the source driver 225 of FIG. 3, the electronic device 200 of FIG. 4C has the features of both of FIGS. 4A and 4B.

In FIG. 4D, conversion data CD[n,x,y] stored in a graphic random access memory (GRAM) 224_d is transmitted to the scaler 227_d. The GRAM 224_d may store the conversion data CD[n,x,y] according to control of a GRAM control block 228_d. Also, the GRAM 224_d may transmit the conversion data CD[n,x,y] to the scaler 227_d according to control of the GRAM control block 228_d.

The scaler 227_e of FIG. 4E is obtained by combining distinctive features of both of FIGS. 4A and 4D. For example, the conversion data CD[n,x,y] stored in the GRAM 224_d is transmitted to the scaler 227_d while using a bypass structure.

For example, the scaler 227_e may generate recovery data RD[n,x,y] by receiving conversion data CD[n,x,y]. The recovery data RD[n,x,y] and display data DD[n,x,y] may be transmitted to the first multiplexer MUX1. The first multiplexer MUX1 may generate selection data SD[n,x,y] by selecting one of the recovery data RD[n,x,y] and the display data DD[n,x,y] according to display characteristic information FI[n] of each frame.

Also, a GRAM 224_e may store the conversion data CD[n,x,y] according to control of a GRAM control block 228_e. Also, the GRAM 224_e may transmit the conversion data CD[n,x,y] to the scaler 227_e according to control of the GRAM control block 228_e.

Accordingly, the electronic device 200 according to the current embodiment uses a GRAM and transmits the display data DD[n,x,y] that is bypassed to the source driver 225 of FIG. 3, and thus, original data may be displayed in more detail.

FIG. 5 shows timing diagrams for describing display driving signals according to embodiments of the present invention.

FIG. 5 (a) is a timing diagram of general driving signals. Referring to FIG. 5 (a), an AP may generate a horizontal synchronization signal HSYNC1 and a data enable signal DE1 such that the data enable signal DE1 is toggled between toggling of the horizontal synchronization signal HSYNC1. The AP may generate and transmit the horizontal synchronization signal HSYNC1, the data enable signal DE1, and a clock signal CLK1 to a DDI.

FIG. 5 (b) is a timing diagram of driving signals according to an embodiment of the present invention. Referring to FIG. 5 (b), the AP 210 may generate a horizontal synchronization signal HSYNC2 and a data enable signal DE2 such that the data enable signal DE2 is toggled less frequently than the data enable signal DE1 between toggling of the horizontal synchronization signal HSYNC2.

For example, the AP 210 may generate the data enable signal DE2 such that the data enable signal DE2 is toggled after every second toggling of the horizontal synchronization signal HSYNC2. Since cycles where data enable signal DE2 is not toggled may exist between toggling of the horizontal synchronization signal HSYNC2, the AP 210 may generate the data enable signal DE2 relatively less frequent than the data enable signal DEL

The horizontal synchronization signal HSYNC2 and the data enable signal DE2 may be driven in synchronization to a clock signal CLK2. FIG. 5 (c) is a timing diagram of driving signals according to another embodiment of the present invention. Referring to FIG. 5 (c), the AP 210 may generate a horizontal synchronization signal HSYNC3 and a data enable signal DE3 such that the data enable signal DE3 is toggled between toggling of the horizontal synchronization signal HSYNC3 while transmitting data. The AP 210 may generate the horizontal synchronization signal HSYNC3 such that the horizontal synchronization signal HSYNC3 has a relatively longer toggling cycle, thereby generating the data enable signal DE3 having a relatively shorter toggling cycle. The horizontal synchronization signal HSYNC3 and the data enable signal DE3 may be driven in synchronization to a clock signal CLK3.

FIG. 5 (d) is a timing diagram of driving signals according to another embodiment of the present invention. Referring to FIG. 5 (d), the AP 210 may generate a horizontal synchronization signal HSYNC4 and a data enable signal DE4 such that the data enable signal DE4 is toggled between toggling of the horizontal synchronization signal HSYNC4 while transmitting data. The horizontal synchronization signal HSYNC4 and the data enable signal DE4 are driven in synchronization with a clock signal CLK4. Since a frequency of the clock signal CLK4 is low, power consumption of a display driving signal used in the electronic device 200 may be reduced.

According to an embodiment, the AP 210 may reduce an amount of display data transferred between the AP 210 and the DDI 220, thereby reducing power consumption of the electronic device 200.

According to an embodiment, the electronic device 200 may reduce an amount of display data transferred between the electronic device 200 and another electronic device, thereby reducing power consumption of the electronic device 200 or the other electronic device.

FIG. 6 is a block diagram of an electronic device 300 according to another embodiment of the present invention.

Referring to FIG. 6, the electronic device 300 may include an AP 310, a DDI 320, and a display panel 340.

The AP 310 of the electronic device 300 according to one or more embodiments of the present invention may include a converting unit 311. The converting unit 311 may include the color converter 313. According to an embodiment, the AP 310 of FIG. 6 may be the AP 110 of FIG. 1. According to an embodiment, the converting unit 311 of FIG. 6 may be the converting unit 111 of FIG. 1.

The color converter 313 may receive display characteristic information FI[n] of each frame and display data DD[n,x,y]. The display characteristic information FI[n] of each frame and the display data DD[n,x,y] may be generated by the AP 310 or may be received from the outside.

The color converter 313 may generate conversion data CD[n,x,y] by receiving the display characteristic information FI[n] of each frame and the display data DD[n,x,y].

For example, the color converter 313 may convert first sub-pixel pattern information corresponding to the display data DD[n,x,y] to second sub-pixel pattern information. For example, the color converter 313 may downsize a color space from a signal of an RGB sub-pixel pattern to a signal of a YUV sub-pixel pattern.

For example, display data (for example, the first sub-pixel pattern information) of an RGB sub-pixel pattern of first through fourth pixels P1 through P4 of a first frame may be assumed to be as follows.

DD[n:1, x:100, y:100]=[R1, G1, B1]

DD[n:1, x:101, y:100]=[R2, G2, B2]

DD[n:1, x:100, y:101]=[R3, G3, B3]

DD[n:1, x:101, y:101]=[R4, G4, B4]

In the above, display characteristic information FI[1] may include information that display data of the first pixel P1 of the first frame is display data of an RGB sub-pixel pattern.

In this case, it may be assumed that display data has a similar value as color data around a respective pixel. Thus, the display characteristic information FI[1] may include information that display data has a similar value as color data around a respective pixel.

In this case, if display data of each sub-pixel is in 8 bits, a total size of display data of the first through fourth pixels P1 through P4 is in 96 bits.

Also, the display data of the RGB sub-pixel pattern of the first through fourth pixels P1 through P4 of the first frame may be converted to display data (for example, the second sub-pixel pattern information) of the YUV sub-pixel pattern to be expressed as follows.

DD[n:1, x:100, y:100]=[Y1, U1, V1]

DD[n:1, x:101, y:100]=[Y2, U1, V1]

DD[n:1, x:100, y:101]=[Y3, U1, V1]

DD[n:1, x:101, y:101]=[Y4, U1, V1]

In the above, Y1 through Y4 denote contrast information and U1 and V1 denote color information. For example, the color information U1 and V1 may be the same throughout the first through fourth pixels P1 through P4, and the contrast information Y1 through Y4 may be different throughout the first through fourth pixels P1 through P4. If display data of each sub-pixel is in 8 bits, a total size of conversion data including the contrast information Y1 through Y4 and the color information U1 and V1 of the first through fourth pixels P1 through P4 is in 48 bits.

When the color converter 313 downsizes the signal of the RGB sub-pixel pattern to the signal of the YUV sub-pixel pattern via color conversion, a size of a signal transmitted from the AP 310 to the DDI 320 may be reduced by 50%, i.e., from 96 bits to 48 bits.

According to another embodiment, the display data (for example, the first sub-pixel pattern information) of the RGB sub-pixel pattern of the first through fourth pixels P1 through P4 of the first frame may be converted to the display data (for example, the second sub-pixel pattern information) of the YUV sub-pixel pattern to be expressed as follows.

DD[n:1, x:100, y:100]=[Y1, U1, V1]

DD[n:1, x:101, y:100]=[Y2, U1, V1]

DD[n:1, x:100, y:101]=[Y3, U2, V2]

DD[n:1, x:101, y:101]=[Y4, U2, V2]

For example, color information U1, V1, U2, and V2 may be the same in the first and second pixels P1 and P2 and in the third and fourth pixels P3 and P4, and contrast information Y1 through Y4 may be different throughout the first through fourth pixels P1 through P4. If display data of each sub-pixel is in 8 bits, display data including the contrast information Y1 through Y4 and the color information U1, V1, U2, and V2 of the first through fourth pixels P1 through P4 is in 64 bits.

When the color converter 313 downsizes the signal of the RGB sub-pixel pattern to the signal of the YUV sub-pixel pattern via color conversion, a size of a signal transmitted from the AP 310 to the DDI 320 may be reduced by about 33%.

The DDI 320 may include a gate driver 321, a logic circuit 323, and a source driver 325.

The gate driver 321, the source driver 325, and the display panel 340 of FIG. 6 may operate similar to the gate driver 121, the source driver 125, and the display panel 140 of FIG. 1, and thus details thereof are not repeated here.

The logic circuit 323 of the electronic device 300 according to one or more embodiments of the present invention may include a color converter 327.

The color converter 327 may generate recovery data RD[n,x,y] by receiving the conversion data CD[n,x,y].

For example, the color converter 327 may convert the second sub-pixel pattern information corresponding to the display data DD[n,x,y] to third sub-pixel pattern information. For example, the color converter 327 may convert the signal of the YUV sub-pixel pattern to a signal of an RGBG pentile sub-pixel pattern.

For example, the display data (for example, the second sub-pixel pattern information) of the YUV sub-pixel pattern of the first through fourth pixels P1 through P4 of the first frame may be expressed as follows.

DD[n:1, x:100, y:100]=[Y1, U1, V1]

DD[n:1, x:101, y:100]=[Y2, U1, V1]

DD[n:1, x:100, y:101]=[Y3, U1, V1]

DD[n:1, x:101, y:101]=[Y4, U1, V1]

Also, display data (for example, the third sub-pixel pattern information) of the YUV sub-pixel pattern of the first through fourth pixels P1 through P4 of the first frame may be expressed as follows.

DD[n:1, x:100, y:100]=[R1, G1]

DD[n:1, x:101, y:100]=[G2, B2]

DD[n:1, x:100, y:101]=[R3, G3]

DD[n:1, x:101, y:101]=[G4, B4]

For example, a total size of display data R1, G1, G2, B2, R3, G3, G4, and B4 of the first through fourth pixels P1 through P4 recovered by the color converter 327 is in 64 bits. When the second sub-pixel pattern information is converted to the third sub-pixel pattern information, a total size of display data of the first through fourth pixels P1 through P4 may be increased from 48 bits to 64 bits. The third sub-pixel pattern information obtained by the color converter 327 may vary according to a structure of the display panel 340.

According to another embodiment, the display data (for example, the second subpixel pattern information) of the YUV sub-pixel pattern of the first through fourth pixels P1 through P4 of the first frame may be expressed as follows.

DD[n:1, x:100, y:100]=[Y1, U1, V1]

DD[n:1, x:101, y:100]=[Y2, U1, V1]

DD[n:1, x:100, y:101]=[Y3, U2, V2]

DD[n:1, x:101, y:101]=[Y4, U3, V3]

Also, the display data (for example, the third sub-pixel pattern information) of the YUV sub-pixel pattern of the first through fourth pixels P1 through P4 of the first frame may be expressed as follows.

DD[n:1, x:100, y:100]=[R1, G1]

DD[n:1, x:101, y:100]=[G2, B2]

DD[n:1, x:100, y:101]=[R3, G3]

DD[n:1, x:101, y:101]=[G4, B4]

For example, a total size of display data R1, G1, G2, B2, R3, G3, G4, and B4 of the first through fourth pixels P1 through P4 recovered by the color converter 327 is in 64 bits. When the second sub-pixel pattern information is converted to the third sub-pixel pattern information, a total size of display data of the first through fourth pixels P1 through P4 may not be changed and may be maintained to be equal to 64 bits.

Since it is assumed that display data has a value similar to color data around a respective pixel, a user is unable to identify a difference between an original object and a restored object with the naked eyes. Thus, an actual shape of an object recognized by the user may be the same.

In the electronic device 300 according to one or more embodiments of the present invention, the AP 310 transmits a relatively small amount of data to the DDI 320, and thus, power consumed to transmit data from the AP 210 to the DDI 320 or from the electronic device 300 to another electronic device may be reduced.

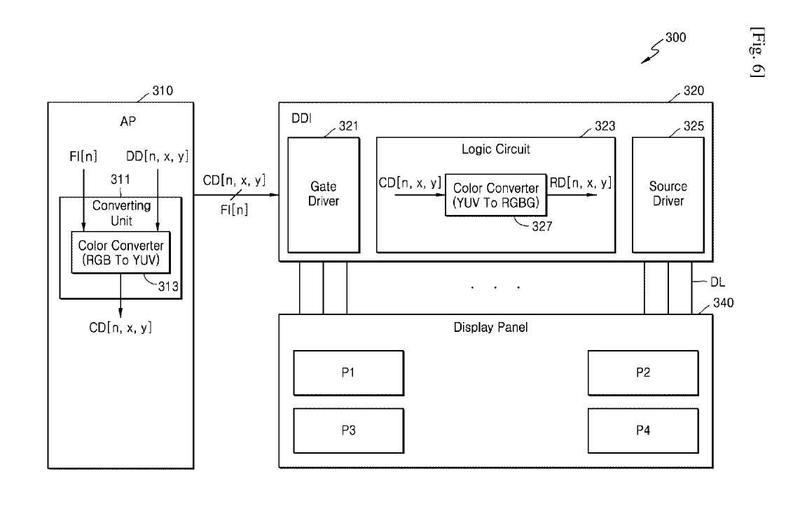

FIG. 7 is a block diagram of an electronic device 400 according to another embodiment of the present invention.

Referring to FIG. 7, the electronic device 400 may include an AP 410, a DDI 420, and a display panel 440.

The AP 410 of the electronic device 400 according to one or more embodiments of the present invention may include a converting unit 411. The converting unit 411 may include the color converter 413. According to an embodiment, the AP 410 of FIG. 7 may be the AP 110 of FIG. 1. According to an embodiment, the converting unit 411 of FIG. 7 may be the converting unit 111 of FIG. 1.

The color converter 413 may receive display characteristic information FI[n] of each frame and display data DD[n,x,y]. The display characteristic information FI[n] of each frame and the display data DD[n,x,y] may be generated by the AP 410 or received from the outside.

The color converter 413 may generate conversion data CD[n,x,y] by receiving the display characteristic information FI[n] of each frame and the display data DD[n,x,y].

For example, the color converter 413 may convert first sub-pixel pattern information corresponding to the display data DD[n,x,y] to second sub-pixel pattern information. For example, the color converter 413 may downsize a signal of an RGB sub-pixel pattern to a signal of an RGBG sub-pixel pattern.

For example, display data (for example, the first sub-pixel pattern information) of RGB sub-pixel pattern of first through fourth pixels P1 through P4 of a first frame may be assumed as follows.

DD[n:1, x:100, y:100]=[R1, G1, B1]

DD[n:1, x:101, y:100]=[R2, G2, B2]

DD[n:1, x:100, y:101]=[R3, G3, B3]

DD[n:1, x:101, y:101]=[R4, G4, B4]

In the above, display characteristic information FI[1] may include information that display data of the first pixel P1 of the first frame is display data of the RGB sub-pixel pattern.

In this case, it may be assumed that display data has a value similar to color data around a respective pixel. Thus, the display characteristic information FI[1] may include information that display data has a value similar to color data around a respective pixel.

In this case, if display data of each sub-pixel is in 8 bits, a total size of display data of the first through fourth pixels P1 through P4 is in 96 bits.

Also, the display data of the RGB sub-pixel pattern of the first through fourth pixels P1 through P4 of the first frame may be converted to display data (for example, the second sub-pixel pattern information) of the RGBG sub-pixel pattern to be expressed as follows.

DD[n:1, x:100, y:100]=[R1, G1]

DD[n:1, x:101, y:100]=[G2, B2]

DD[n:1, x:100, y:101]=[R3, G3]

DD[n:1, x:101, y:101]=[G4, B4]

If display data of each sub-pixel is in 8 bits, a total size of display data R1, G1, G2, B2, R3, G3, G4, and B4 of the first through fourth pixels P1 through P4 may be in 32 bits.

When the color converter 413 downsizes the signal of the RGB sub-pixel pattern to the signal of the RGBG sub-pixel pattern via data conversion, a data amount transmitted from the AP 410 to the DDI 420 may be reduced.

Since it is assumed that display data has a value similar to color data around a respective pixel, a user is unable to identify a difference between an original object and a restored object with the naked eyes. Thus, an actual shape of an object recognized by the user may be the same as that of the original object.

The DDI 420 may include a gate driver 421, a logic circuit 423, and a source driver 425.

The DDI 420 and the display panel 440 of FIG. 7 may operate similar to the DDI 120 and the display panel 140 of FIG. 1, and thus details thereof are not repeated here.

In the electronic device 400 according to one or more embodiments of the present invention, the AP 410 transmits a relatively small amount of data to the DDI 420, and thus power consumed to transmit data from the AP 210 to the DDI 420 or from the electronic device 400 to another electronic device may be reduced.

FIG. 8 is a block diagram of an electronic device 500 according to another embodiment of the present invention.

Referring to FIG. 8, the electronic device 550 may include an AP 510, a DDI 520, and a display panel 540.

The AP 510 of the electronic device 500 according to one or more embodiments of the present invention may include the first converting unit 511. The first converting unit 511 may include a color converter 515 and a downsizing scaler 513. The AP 510 of FIG. 8 may be an embodiment of the AP 110 of FIG. 1. The first converting unit 511 of FIG. 8 may be an embodiment of the converting unit 111 of FIG. 1.

The first converting unit 511 may receive display characteristic information FI[n] of each frame and display data DD[n,x,y]. The display characteristic information FI[n] of each frame and the display data DD[n,x,y] may be generated by the AP 510 or received from outside the AP 510.

The first converting unit 511 may generate conversion data CD[n,x,y] by receiving the display characteristic information FI[n] of each frame and the display data DD[n,x,y].

For example, the color converter 515 may convert first sub-pixel pattern information corresponding to the display data DD[n,x,y] to second sub-pixel pattern information. For example, the color converter 515 may convert a color space by downsizing a signal of an RGB sub-pixel pattern to a signal of a YUV sub-pixel pattern.

For example, display data (for example, the first sub-pixel pattern information) of RGB sub-pixel pattern of first through fourth pixels P1 through P4 of a first frame may be assumed as follows.

DD[n:1, x:100, y:100]=[R1, G1, B1]

DD[n:1, x:101, y:100]=[R2, G2, B2]

DD[n:1, x:100, y:101]=[R3, G3, B3]

DD[n:1, x:101, y:101]=[R4, G4, B4]

In the above, display characteristic information FI[1] may include information that display data of the first pixel P1 of the first frame is display data of the RGB sub-pixel pattern.

In this case, if display data of each sub-pixel is in 8 bits, a total size of display data of first through fourth pixels P1 through P4 is in 96 bits. Also, it may be assumed that display data has a value similar to color data around a respective pixel.

Also, the display data of the RGB sub-pixel pattern of the first through fourth pixels P1 through P4 of the first frame may be preliminarily converted to display data PD[n,x,y] of the YUV sub-pixel pattern to be expressed as follows.

PD[n:1, x:100, y:100]=[Y1, U1, V1]

PD[n:1, x:101, y:100]=[Y2, U1, V1]

PD[n:1, x:100, y:101]=[Y3, U1, V1]

PD[n:1, x:101, y:101]=[Y4, U1, V1]

In the above, Y1 through Y4 denote contrast information, and U1 and V1 denote color information. For example, the color information U1 and V1 may be the same throughout the first through fourth pixels P1 through P4, and the contrast information Y1 through Y4 may be different throughout the first through fourth pixels P1 through P4.

Also, the downsizing scaler 513 may compress display data of a plurality of adjacent pixels to display data of one pixel. For example, the downsizing scaler 513 may downsize display data (for example, the second sub-pixel pattern information) of the YUV sub-pixel pattern from a signal of a 1000×2000 pixel array to a signal of a 500×1000 pixel array.

The downsizing scaler 513 may calculate conversion data CD[n,x,y] corresponding to the 500×1000 pixel array as follows.

CD[n:1, x:50, y:50]=[Y1, U1, V1]

Display data transmitted from the AP 510 to the DDI 520 may be reduced to 24 bits.

However, a downsizing method performed by the downsizing scaler 513 does not limit the scope of the invention. For example, the downsizing scaler 513 may calculate the conversion data CD[n,x,y] as follows.

CD[n:1, x:50, y:50]=[(Y1+Y2+Y3+Y4)/4, U1, V1]

Since the AP 510 transmits display data in 96 bits to the DDI 520 after downsizing the display data in 96 bits to display data in 24 bits, power consumption may be reduced.

The DDI 520 may include a gate driver 521, a logic circuit 523, and a source driver 525.

The source driver 525 and the display panel 540 of FIG. 8 may operate similarly to the source driver 125 and the display panel 140 of FIG. 1, and thus details thereof are not repeated here.

The logic circuit 523 of the electronic device 500 according to one or more embodiments of the present invention may include a second converting unit 527. The second converting unit 527 may include at least one of a color converter 522 and an upsizing scaler 524.

The second converting unit 527 may generate recovery data RD[n,x,y] by receiving the conversion data CD[n,x,y].

For example, the upsizing scaler 524 may upsize the second sub-pixel pattern information corresponding to the conversion data CCD[n,x,y]. For example, the display data (for example, the second sub-pixel pattern information) of the YUV sub-pixel pattern of the first through fourth pixels P1 through P4 of the first frame may be expressed as follows.

CD[n:1, x:50, y:50]=[Y1, U1, V1]

Also, display data UD[n,x,y] of the YUV sub-pixel pattern of the first through fourth pixels P1 through P4 of the first frame obtained via the upsizing may be expressed as follows.

UD[n:1, x:100, y:100]=[Y1, U1, V1]

UD[n:1, x:101, y:100]=[Y1, U1, V1]

UD[n:1, x:100, y:101]=[Y1, U1, V1]

UD[n:1, x:101, y:101]=[Y1, U1, V1]

Also, the color converter 522 may convert the display data UD[n,x,y] of the YUV sub-pixel pattern of the first through fourth pixels P1 through P4 of the first frame obtained via the upsizing to display data (for example, the recovery data RD[n,x,y]) of the RGBG sub-pixel pattern as follows.

RD[n:1, x:100, y:100]=[R1, G1]

RD[n:1, x:101, y:100]=[G2, B2]

RD[n:1, x:100, y:101]=[R3, G3]

RD[n:1, x:101, y:101]=[G4, B4]

In the above, a total size of display data R1, G1, G2, B2, R3, G3, G4, and B4 of the first through fourth pixels P1 through P4 obtained via the recovery is 64 bits. By upsizing the second sub-pixel pattern information to third sub-pixel pattern information, a total size of the display data of the first through fourth pixels P1 through P4 may be increased from 12 bits to 64 bits. In this case, a method of converting data, which is performed by the second converting unit 527, may vary according to a structure of the display panel 540.

Since it is assumed that display data has a value similar to color data around a respective pixel, a user is unable to identify a difference between an original object and a restored object with the naked eyes. Thus, an actual shape of an object recognized by the user may be the same as that of the original object.

In the electronic device 500 according to one or more embodiments of the present invention, the AP 510 transmits a relatively small amount of data to the DDI 520, and thus power consumed to transmit data may be reduced.

FIG. 9 is a block diagram of an electronic device 600 according to another embodiment of the present invention.

Referring to FIG. 9, the electronic device 600 may include an AP 610, a DDI 620, and a display panel 640.

The DDI 620 may include a gate driver 621, a logic circuit 623, and a source driver 625.

The gate driver 621, the source driver 625, and the display panel 640 may operate similarly to the gate driver 121, the source driver 125, and the display panel 140 of FIG. 1, and thus details thereof are not repeated here.

The AP 610 of the electronic device 600 according to one or more embodiments of the present invention may include a converting unit 611. The converting unit 611 may include a color converter 615 and a downsizing scaler 613. The AP 610 of FIG. 9 may be an embodiment of the AP 110 of FIG. 1. The converting unit 611 of FIG. 9 may be an embodiment of the converting unit 111 of FIG. 1.

The converting unit 611 may receive display characteristic information FI[n] of each frame and display data DD[n,x,y]. The display characteristic information FI[n] of each frame and the display data DD[n,x,y] may be generated by the AP 610 or received from outside the AP 610.

The converting unit 611 may generate conversion data CD[n,x,y] by receiving the display characteristic information FI[n] of each frame and the display data DD[n,x,y].

For example, the color converter 615 may convert first sub-pixel pattern information corresponding to the display data DD[n,x,y] to second sub-pixel pattern information. For example, the color converter 615 may downsize a signal of an RGB sub-pixel pattern to a signal of an RGBG sub-pixel pattern.

For example, it may be assumed that display data (for example, the first sub-pixel pattern information) of an RGB sub-pixel pattern of first through fourth pixels P1 through P4 of a first frame is as follows.

DD[n:1, x:100, y:100]=[R1, G1, B1]

DD[n:1, x:101, y:100]=[R2, G2, B2]

DD[n:1, x:100, y:101]=[R3, G3, B3]

DD[n:1, x:101, y:101]=[R4, G4, B4]

Information that display data of the first pixel P1 of the first frame is display data of the RGB sub-pixel pattern may be included in display characteristic information FI[1].

In this case, if display data of each sub-pixel is in 8 bits, a total size of display data of the first through fourth pixels P1 through P4 may be 96 bits. Also, it may be assumed that display data has a value similar to color data around a respective pixel.

Also, the display data of the RGB sub-pixel pattern of the first through fourth pixels P1 through P4 of the first frame may be preliminarily converted to display data PD[n,x,y] of the RGBG sub-pixel pattern to be expressed as follows.

PD[n:1, x:100, y:100]=[R1, G1]

PD[n:1, x:101, y:100]=[G2, B2]

PD[n:1, x:100, y:101]=[R3, G3]

PD[n:1, x:101, y:101]=[G4, B4]

If display data of each sub-pixel is in 8 bits, a total size of display data R1, G1, G2, B2, R3, G3, G4, and B4 of the first through fourth pixels P1 through P4 is 64 bits.

Also, the downsizing scaler 613 may compress display data of a plurality of adjacent pixels to display data of one pixel. For example, the downsizing scaler 613 may downsize display data of a YUV sub-pixel pattern from a signal of a 1000×2000 pixel array to a signal of a 1000×1000 pixel array.

For example, it may be assumed that display data of a YUV sub-pixel pattern of a 1×2 pixel group that is a part of a 1000×2000 pixel array of the first frame has a value similar to color data around a respective pixel. Such similarity is included in the display characteristic information FI[1] of the first frame.

The downsizing scaler 613 may calculate the conversion data CD[n,x,y] corresponding to a 500×100 pixel array as follows.

CD[n:1, x:100, y:50]=[R1, G1]

CD[n:1, x:101, y:50]=[G2, B2]

Display data transmitted from the AP 610 to the DDI 620 may be reduced to 32 bits.

However, a downsizing method performed by the downsizing scaler 613 does not limit the scope of the invention. For example, the downsizing scaler 613 may calculate the conversion data CD[n,x,y] as follows.

CD[n:1, x:100, y:50]=[(R1+R3)/2, (G1+G3)/2]

CD[n:1, x:101, y:50]=[(R2+R4)/2, (G2+G4)/2]

Since the AP 610 transmits display data in 96 bits to the DDI 620 after downsizing the display data in 96 bits to display data in 32 bits, power consumption may be reduced by about 66%.

The logic circuit 623 of the electronic device 600 according to one or more embodiments of the present invention may include an upsizing scaler 627.

The upsizing scaler 627 may generate recovery data RD[n,x,y] by receiving the conversion data CD[n,x,y]. Detailed operations are as follows.

Also, the upsizing scaler 627 may upsize display data of an RGBG sub-pixel pattern of the first through fourth pixels P1 through P4 of the first frame as follows.

RD[n:1, x:100, y:100]=[R1, G1]

RD[n:1, x:101, y:100]=[G2, B2]

RD[n:1, x:100, y:101]=[R1, G1]

RD[n:1, x:101, y:101]=[G2, B2]

A method of converting data, which is performed by the upsizing scaler 627 may vary according to a structure of the display panel 640.

Since it is assumed that display data has a value similar to color data around a respective pixel, a user is unable to identify a difference between an original object and a restored object with the naked eyes. Thus, an actual shape of an object recognized by the user may be the same as that of the original object.

In the electronic device 600 according to one or more embodiments of the present invention, the AP 610 transmits a relatively small amount of data to the DDI 620, and thus power consumed to transmit data from the AP 610 to the DDI 620 or from the electronic device 600 to another electronic device may be reduced.

FIG. 10 is a block diagram of an electronic device 700 according to another embodiment of the present invention.

Referring to FIG. 10, the electronic device 700 may include an AP 710, an DDI 720, and a display panel 740.

The AP 710 of the electronic device 700 according to one or more embodiments of the present invention may include a converting unit 711. The converting unit 711 may include the circular sampler 713. The AP 710 of FIG. 10 may be an embodiment of the AP 110 of FIG. 1. The converting unit 711 of FIG. 10 may be an embodiment of the converting unit 111 of FIG. 1.

The circular sampler 713 may receive display characteristic information FI[n] of each frame and display data DD[n,x,y], wherein n denotes a frame number, and x and y denote pixel address values.

The circular sampler 713 may generate conversion data CD[n,x,y] by receiving the display characteristic information FI[n] of each frame or the display data DD[n,x,y].

For example, the circular sampler 713 may sample pixels corresponding to at least one pixel group from among a plurality of pixel groups included in a pixel block including a plurality of pixels.

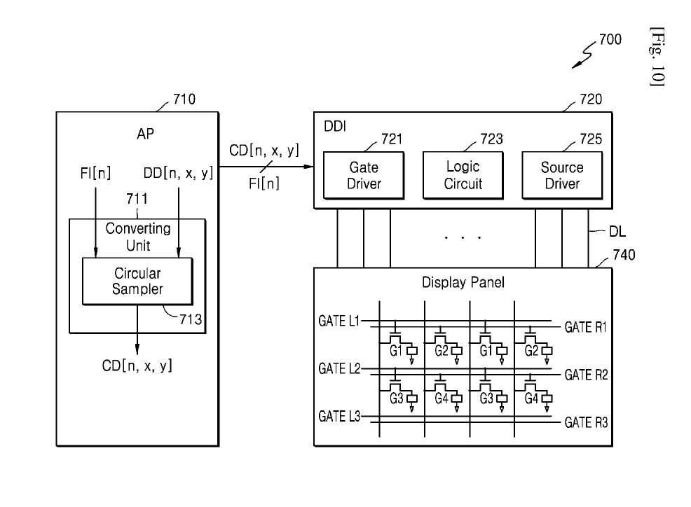

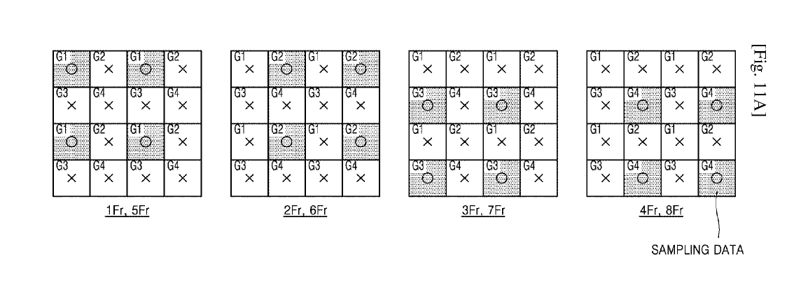

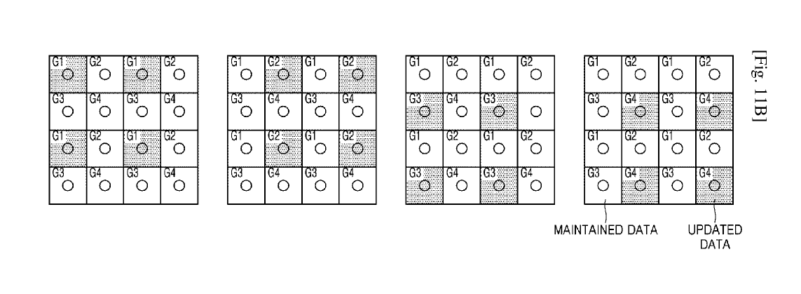

FIG. 11A is a diagram for describing a method of sampling, by the circular sampler 713 of the electronic device 700 of FIG. 10, a pixel group corresponding to each frame.

Referring to FIGS. 10 and 11A, the circular sampler 713 may sample information about pixels included in a first group G1 from sampling of a first frame 1Fr. Also, the circular sampler 713 may sample information about pixels included in a second group G2 from sampling of a second frame 2Fr. Also, the circular sampler 713 may sample information about pixels included in a third group G3 from sampling of a third frame 3Fr. Also, the circular sampler 713 may sample information about pixels included in a fourth group G4 from sampling of a fourth frame 4Fr. Continuously, information about pixels included in the first through fourth groups G1 through G4 may be sampled respectively from samplings of fifth through eighth frames 5Fr through 8Fr.

It may be assumed that values of display data are similar between consecutive frames. Such similarity is included in display characteristic information FI[n] of each frame.

Referring back to FIG. 10, the AP 710 may transmit the conversion data CD[n,x,y] sampled as such to the DDI 720. The DDI 720 may transmit the received the conversion data CD[n,x,y] to a logic circuit 723. Since the AP 710 transmits one piece of data to the DDI 720 as a representative of four pieces of data, the AP 710 may have low power consumption.

The DDI 720 may include a gate driver 721, the logic circuit 723, and a source driver 725.

The logic circuit 723 according to one or more embodiments of the present invention may receive a signal obtained by sampling different groups per frame, and drive the source driver 725 accordingly.

FIG. 11B is a diagram for describing a method of sampling, by the logic circuit 723 of the electronic device 700 of FIG. 10, a pixel group corresponding to each frame.

Referring to FIGS. 10 and 11B, a synchronization signal corresponding to the first frame 1Fr may update display data only for the pixels included in the first group G1. For example, display data of the pixels included in the second, third, and fourth groups G2, G3, and G4 may be maintained and only the display data of the pixels included in the first group G1 may be updated in response to the synchronization signal corresponding to the first frame 1Fr.

Also, a synchronization signal corresponding to the second frame 2Fr may update the display data only for the pixels included in the second group G2. For example, the display data of the pixels included in the first, third, and fourth groups G1, G3, and G4 may be maintained and only the display data of the pixels included in the second group G2 may be updated in response to the synchronization signal corresponding to the second frame 2Fr.

Continuously, similar to the first and second frames 1Fr and 2Fr, a synchronization signal corresponding to the third frame 3Fr may update the display data only for the pixels included in the third group G3. Also, a synchronization signal corresponding to the fourth frame 4Fr may update the display data only for the pixels included in the fourth group G4.

Referring back to FIG. 10, the display panel 740 according to the current embodiment may include two gate lines per one row. For example, when the display data of the pixels included in the first and third groups G1 and G3 are updated, gate lines GATE L1 through GATE L3 may be activated. Also, when the display data of the pixels included in the second and fourth groups G2 and G4 are updated, gate lines GATE R1 through GATE R3 may be activated.

However, the above descriptions do not limit the scope of the invention, and the number of pixels included in one group and the number of pixel groups may vary according to embodiments. For example, as shown in FIG. 11C, data may be alternately sampled according to odd columns or even columns, or as shown in FIG. 11D, data may be alternately sampled according to odd-th rows or even-th rows.

Since it is assumed that values of display data are similar between consecutive frames, a user is unable to identify a difference between an original object and a restored object. Thus, an actual shape of an object recognized by the user may not change.

In the electronic device 700 according to one or more embodiments of the present invention, the AP 710 transmits a relatively small amount of data to the DDI 720, and thus power consumed to transmit data from the AP 710 to the DDI 720 or from the electronic device 700 to another electronic device may be reduced.

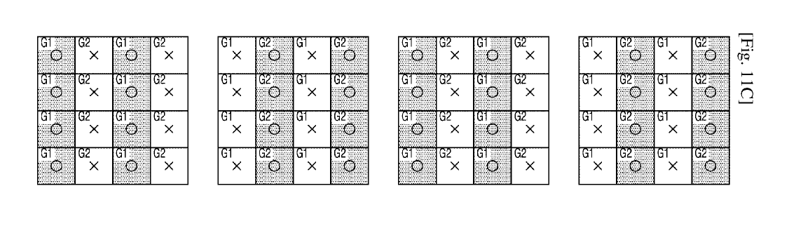

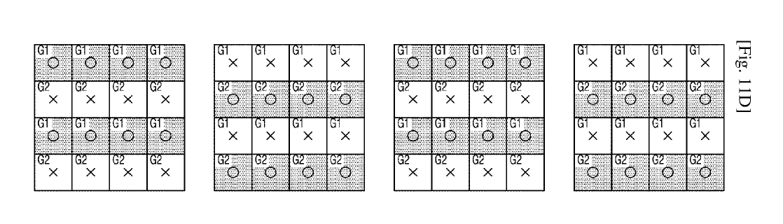

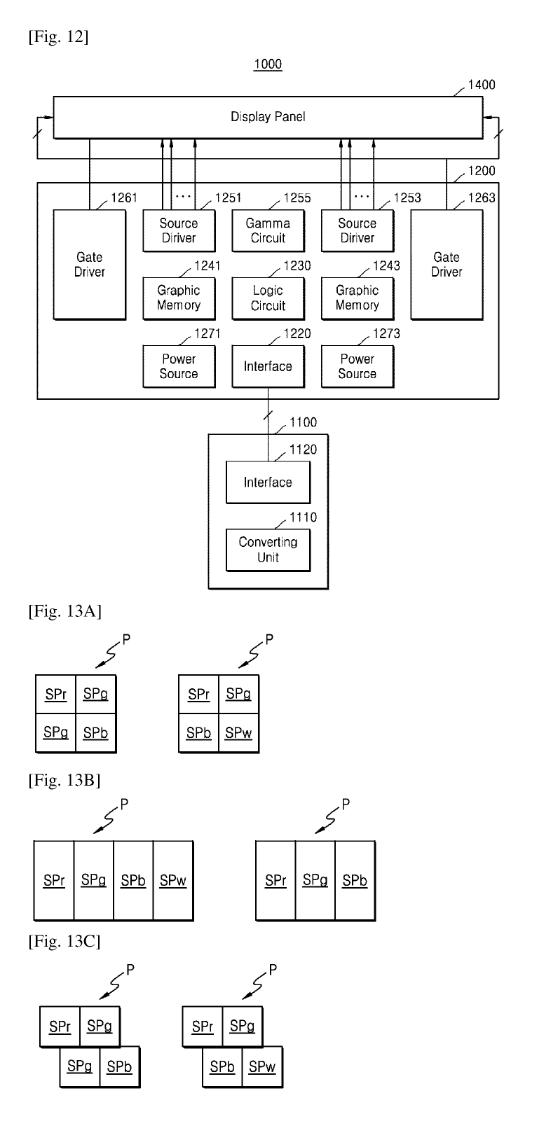

FIG. 12 is a block diagram of an electronic device 1000 according to another embodiment of the present invention.

Referring to FIG. 12, the electronic device 1000 may include a DDI 1200, an AP 1100, and a display panel 1400.

The electronic device 1000 may be an electronic device including the display panel 1400.

The DDI 1200 may display display data on the display panel 1400 according to control of a processor, for example, the AP 1100. When the DDI 120 is used in a mobile device, the DDI 1200 may also be referred to as a mobile DDI.

The DDI 1200 may include an interface 1220, a logic circuit 1230, and at least one graphic memory, i.e. graphic memories 1241 and 1243.

The interface 1220 of the DDI 120 may communicate with an interface 1120 of the AP 1100.

The interfaces 1220 and 1120 may each be a serial interface, such as an MIPI interface (MIPI®), a mobile display digital interface (MDDI), a display port, or an embedded display port (eDP).

For example, the interfaces 1220 and 1120 may each be an MIPI® or a display serial interface (DSI).

The graphic memories 1241 and 1243 may process (for example, store) image data or graphic data to be displayed on the display panel 1400. Although not shown in FIG. 12, a line buffer may be used instead of the graphic memories 1241 and 1243 according to another embodiment of the present invention.

The DDI 1200 may further include at least one source driver, i.e., source drivers 1251 and 1253, a gamma circuit 1255, at least one gate driver, i.e., gate drivers 1261 and 1263, and at least one power source, i.e., power sources 1271 and 1273.

In FIG. 12, the two source drivers 1251 and 1253, the gamma circuit 1255, the two gate drivers 1261 and 1263, and the two power sources 1271 and 1273 are illustrated, but a structure of the DDI 1200 according to the current embodiment of the present invention is not limited thereto.

The source drivers 1251 and 1253 may generate signals corresponding to image data or graphic data output from the graphic memories 1241 and 1243 to data lines of the display panel 1400 by using respective gamma voltages output from the gamma circuit 1255.

The gate drivers 1261 and 1263 may drive gate lines of the display panel 1400.

For example, since operations of pixels of the display panel 1400 are controlled by the source drivers 1251 and 1253 and the gate drivers 1261 and 1263, an image corresponding to the image data or graphic data output from the graphic memories 1241 and 1243 may be displayed on the display panel 1400.

The two power sources 1271 and 1273 may supply power to each of the interface 1220, the logic circuit 1230, the graphic memories 1241 and 1243, the source drivers 1251 and 1253, the gamma circuit 1255, the gate drivers 1261 and 1263, and the display panel 1400.

The electronic device 1000 may include the display panel 1400. The display panel 1400 may be a thin-film transistor-liquid crystal display (TFT-LCD), an LED display, an OLED display, an AMOLED display, or a flexible display.

The display panel 1400 may be, for example, flexible, transparent, or wearable. The display panel 140 and a touch panel may form one module.

According to an embodiment, a hologram unit that realizes a stereoscopic image in the air by using interference of light may be used instead of the display panel 1400. According to an embodiment, a projector that displays an image by projecting light on a screen may be used instead of the display panel 1400. The screen may be located inside or outside the electronic device 1000.

The AP 1100 according to one or more embodiments of the present invention may include a converting unit 1110. The converting unit 1110 may be realized according to any embodiment described above with reference to FIGS. 3 through 10. For example, the converting unit 1110 may include the downsizing scaler 213 of FIG. 3, the color converter 311 or 411 of FIG. 6 or 7, the first converting unit 511 of FIG. 8, the converting unit 611 of FIG. 9, the circular sampler 713 of FIG. 10, or a combination thereof.

Accordingly, a relatively low amount of power may be used to transmit display data to the DDI 1200.

FIG. 13 illustrates various patterns of sub-pixels in one pixel P included in any one of the display panels 140, 240, 340, 440, 540, 640, and 740, according to embodiments of the present invention.

Referring to FIG. 13, the sub-pixels in one pixel P may have a checker pattern wherein two data lines and two gate lines are alternately arranged as shown in FIG. 13 (a), or may have a stripe pattern wherein three or four data lines and one gate line are alternately arranged as shown in FIG. 13 (b). Alternatively, the sub-pixels in one pixel P may have a pattern wherein two data lines and two gate lines are alternately arranged to form a checkered pattern while the sub-pixels on an upper row and the sub-pixels on a lower row are misaligned, as shown in FIG. 13 (c).

However, the various patterns of the sub-pixels included in the display panels 140, 240, 340, 440, 540, 640, and 740 may vary and do not limit the scope of the invention.

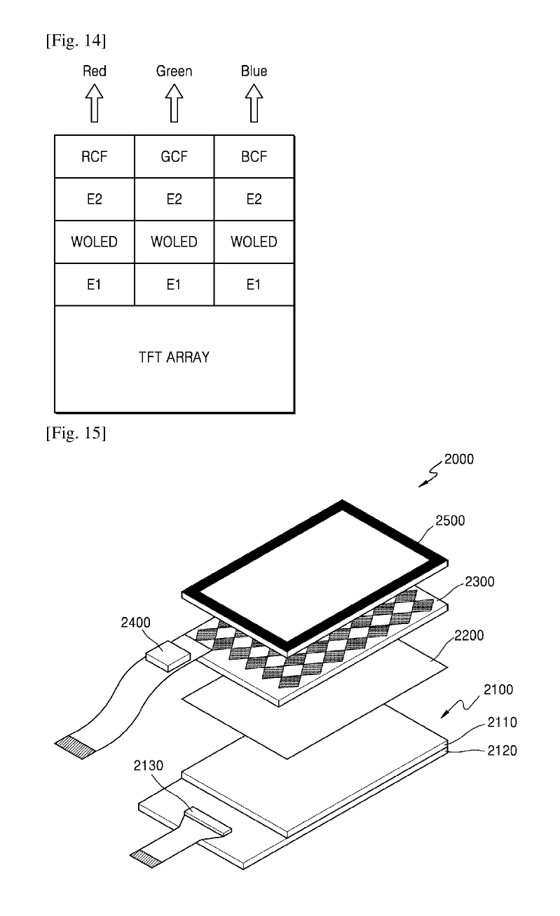

FIG. 14 is a diagram of a stacked structure of red, green, and blue sub-pixels in one pixel included in the display panels 140, 240, 340, 440, 540, 640, and 740 according to embodiments of the present invention.

Referring to FIG. 14, the red, green and blue sub-pixels SPr, SPg, and SPb may each include a white OLED (WOLED). The WOLED has a structure in which a red emission layer, a green emission layer, and a blue emission layer are selectively stacked on each other between a cathode and an anode. The WOLED is formed in units of sub-pixels. As shown in FIG. 14, the red sub-pixel SPr may include a red color filter RCF that only transmits red light from white light incident from the WOLED, the green sub-pixel SPg may include a green color filter GCF that only transmits green light from white light incident from the WOLED, and the blue sub-pixel SPb may include a blue color filter BCF that only transmits blue light from white light incident from the WOLED.

In FIG. 14, ‘E1’ may denote an anode (or a cathode), and ‘E2’ may denote a cathode (or an anode). ‘E1’ is electrically connected to a driving TFT formed on a TFT array below ‘E1’, in units of sub-pixels. The TFT array may include the driving TFT, at least one switching TFT, and a storage capacitor according to sub-pixels, and may be connected to a data line and a gate line in units of sub-pixels.

The stacked structure of the red, green, and blue sub-pixels may vary according to embodiments, and does not limit the scope of the invention. For example, the red, green, and blue sub-pixels may have a PenTile structure, or a white sub-pixel having no color filter may be further included in the pixel.

FIG. 15 is a diagram of a display module 2000 according to an embodiment of the present invention.

Referring to FIG. 15, the display module 2000 may include an electronic device 2100, a polarizing plate 2200, and a window glass 2500. The electronic device may include a display panel 2110, a print board 2120, and a display driving chip 2130.

The window glass 2500 may be generally formed of a material such as acryl or tempered glass to protect the display module 2000 from external shocks or scratches caused by repeated touches. The polarizing plate 2200 may be used to reinforce an optical characteristic of the display panel 2110. The display panel 2110 is formed on the print board 2120 by patterning a transparent electrode. The display panel 2110 may include a plurality of pixel cells for displaying a frame. According to one or more embodiments, the display panel 2110 may be an OLED panel. Each pixel cell may include an OLED that emits light in response to a current flow. However, alternatively, the display panel 2110 may include any one of various types of display devices. For example, the display panel 2110 may include one of an LCD, an electrochromic display (ECD), a digital mirror device (DMD), an actuated mirror device (AMD), a grating light value (GLV) display, a plasma display panel (PDP), an electroluminescent display (ELD), an LED display, or a vacuum fluorescent display (VFD).

The display driving chip 2130 may include one of the DDI 120, 220, 320, 420, 520, 620, and 720 according to the embodiments of the present invention. In the current embodiment, one display driving chip 2130 is illustrated, but alternatively, a plurality of the display driving chips 2130 may be used. Also, the display driving chip 2130 may be mounted on the print board 2120 formed of a glass material in a chip-on-glass (COG) form. Alternatively, the display driving chip 2130 may be mounted in any one of various forms, such as a chip-on-film (COF) form or a chip-on-board (COB) form.

The display module 2000 may further include a touch panel 2300 and a touch controller 2400. The touch panel 2300 is formed by patterning a transparent electrode formed of, for example, indium tin oxide (ITO) on a glass substrate or a polyethylene terephthalate (PET) film. The touch controller 2400 may calculate a touch coordinate by detecting a touch on the touch panel 2300, and transmit the touch coordinate to a host (not shown). The touch controller 2400 and the display driving chip 2130 may be integrated into one semiconductor chip.

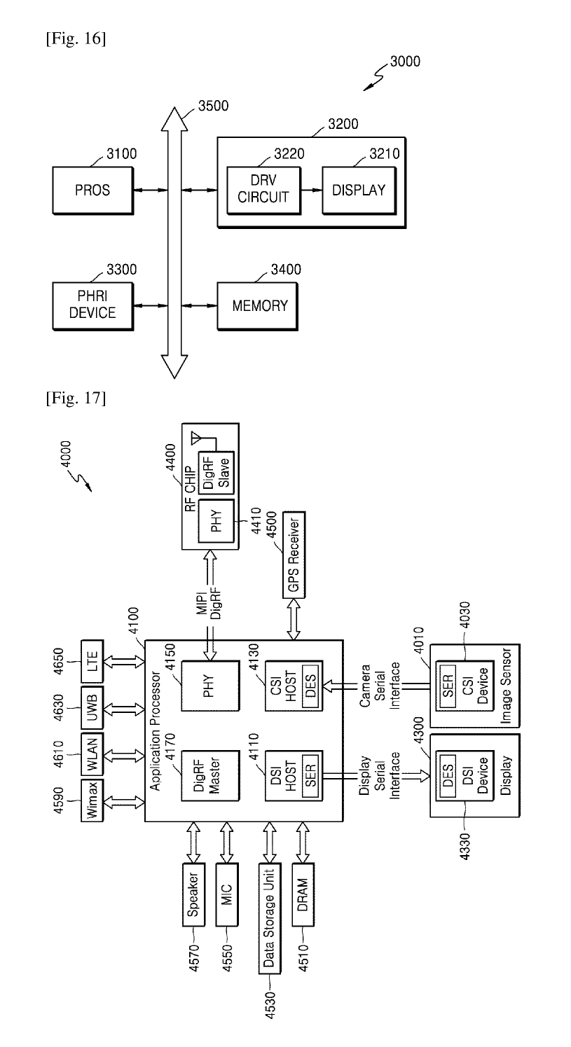

FIG. 16 is a block diagram of a display system 3000 according to an embodiment of the present invention.

Referring to FIG. 16, the display system 3000 may include a processor 3100, an electronic device 3200, a peripheral device 3300, and a memory 3400, which are electrically connected to a system bus 3500.

The processor 3100 controls inputting and outputting of data to and from the peripheral device 3300, the memory 3400, and the electronic device 3200, and may process an image corresponding to image data transferred between the peripheral device 3300, the memory 3400, and the electronic device 3200.

The electronic device 3200 includes a display 3210 and a driving circuit 3220, and may store image data received through the system bus 3500 in a frame memory included in the driving circuit 3220 and display the image data on the display 3210. The electronic device 3200 may be any one of the electronic devices 100, 200, 300, 400, 500, 600, and 700 according to the embodiments of the present invention.

The peripheral device 3300 may be a device that converts a video or a still image captured by a camera, a scanner, or a webcam to an electric signal. Image data obtained by the peripheral device 3300 may be stored in the memory 3400 or displayed on a panel of the electronic device 3200 in real-time.

The memory 3400 may include a volatile memory device, such as a dynamic random access memory (DRAM), and/or a nonvolatile memory device, such as a flash memory. The memory 3400 may include a DRAM, a phase change RAM (PRAM), a magnetic RAM (MRAM), a resistance RAM (ReRAM), a ferroelectric RAM (FRAM), an NOR flash memory, a NAND flash memory, or a fusion flash memory (for example, a memory in which a static RAM (SRAM) buffer, a NAND flash memory, and a NOR interface logic are combined to each other). The memory 3400 may store image data obtained by the peripheral device 3300 or an image signal processed by the processor 3100.

The display system 3000 according to an embodiment of the present invention may be included in a mobile electronic product, such as a smart phone, but is not limited thereto. The display system 3000 may be included in any one of various types of electronic products that display images.

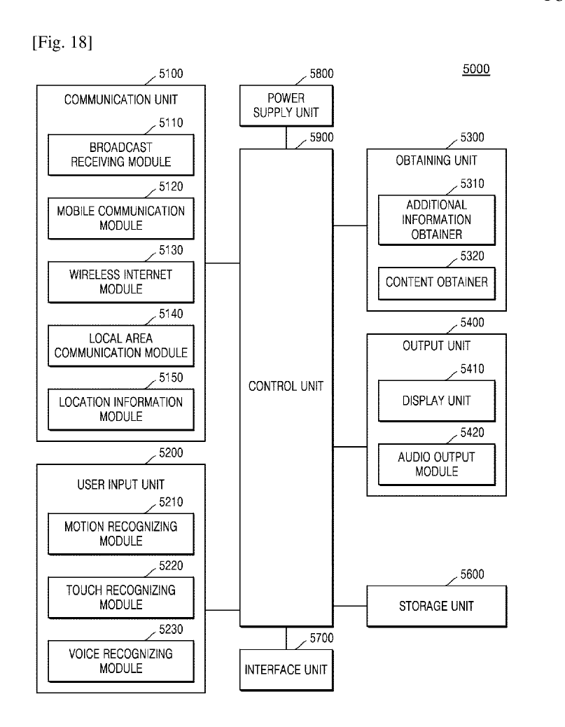

FIG. 17 is a block diagram of a display system 4000 according to another embodiment of the present invention.

Referring to FIG. 17, the display system 4000 may be an electronic device having a display function capable of using or supporting MIPI®.

The display system 4000 may be an electronic device including a display 4300. The electronic device may be the electronic device having the display function described above with reference to FIG. 1, or an electronic device having a communication function.

The display system 4000 may include an AP 4100, an image sensor 4010, and the display 4300.

A camera serial interface (CSI) host 4130 included in the AP 4100 may communicate in series with a SCI device 4030 of the image sensor 4010 through a CSI.

According to an embodiment, a deserializer (DES) may be included in the CSI host 4130 and a serializer (SER) may be included in the CSI device 4030.

A display serial interface (DSI) host 4110 included in the AP 4100 may communicate in series with a DSI device 4330 of the display 4300 through a DSI.

The DSI host 4110 may include the downsizing scaler 213 of FIG. 3, the color converter 311 or 411 of FIG. 6 or 7, the first converting unit 511 of FIG. 8, the converting unit 611 of FIG. 9, the circular sampler 713 of FIG. 10, or a combination thereof, according to one or more embodiments of the present invention.

Also, the DSI device 4330 may be any one of the DDI 120, 220, 320, 420, 520, 620, and 720 according to the embodiments of the present invention.

According to an embodiment, an SER may be included in the DSI host 4110, and a DES may be included in the DSI device 4330. The DES and the SER may each process an electric signal or an optical signal.

The display system 4000 may further include a radio frequency (RF) chip 4400 capable of communicating with the AP 4100. A physical layer (PHY) 4150 of the AP 4100 and a PHY 4410 of the RF chip 4400 may exchange data according to MIPI DigRF.

The display system 4000 may further include a global positioning system (GPS) receiver 4500, a memory, such as a DRAM 4510, a data storage unit 4530 that is a nonvolatile memory, such as a NAND flash memory, a microphone 4550, and a speaker 4570.

The display system 4000 may communicate with an external device by using at least one communication protocol or communication standard, such as worldwide interoperability for microwave access (WiMAX) 4590, wireless LAN (WLAN) 4610, ultrawideband (UWB) 4630, or a long term evolution (LTE) 4650.

The display system 4000 may communicate with an external device by using a Bluetooth or WiFi.

The display system 4000 according to one or more embodiments of the present invention may use a relatively low amount of power while transferring data between the AP 4100 and the DSI device 4330.

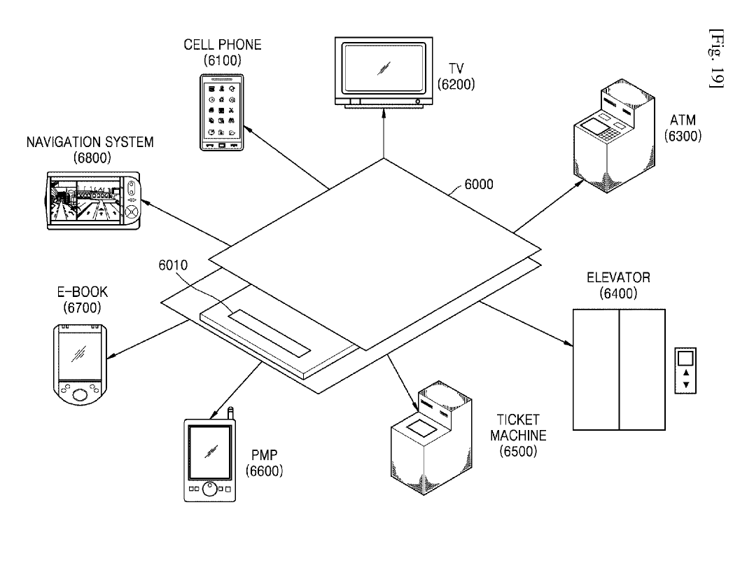

FIG. 18 is a block diagram of a mobile electronic device 5000 related to one or more embodiments of the present invention.

Referring to FIG. 18, the mobile electronic device 5000 according to one or more embodiments of the present invention may include a communication unit 5100, a user input unit 5200, an obtaining unit 5300, an output unit 5400, a storage unit 5600, an interface unit 5700, a power supply unit 5800, and a control unit 5900. However, not all components shown in FIG. 18 are essential, and thus, the mobile electronic device 5000 may include more or less components.

The components of FIG. 18 will now be described in detail.

The communication unit 5100 may include at least one component enabling communication between the mobile electronic device 5000 and another mobile electronic device, or between networks where the mobile electronic device 5000 and the other mobile electronic device are located. For example, the communication unit 5100 may include a broadcast receiving module 5110, a mobile communication module 5120, a wireless internet module 5130, a local area communication module 5140, and a location information module 5150.

The broadcast receiving module 5110 may receive a broadcast signal and/or broadcast-related information from an external broadcast management server through a broadcast channel.

The mobile communication module 5120 may transmit and receive a wireless signal to and from a base station, an external display device, and a server in a mobile communication network. The wireless signal may contain various types of data according to transmitting and receiving a voice call signal, a video call signal, or a text/multimedia message.

The wireless internet module 5130 is a module for wireless internet access, and may be mounted inside or outside the mobile electronic device 5000.

The local area communication module 5140 may include a module for local area communication. Examples of a local area communication technology include WLAN (Wi-Fi), Bluetooth, Zigbee, WFD, UWB, and infrared data association (IrDA), but are not limited thereto.

The location information module 5150 is a module for determining or obtaining a location of the mobile electronic device 5000. For example, the location information module 5150 may be a GPS module. The GPS module may receive location information from a plurality of satellites. The location information may contain coordinate information displayed as latitude and longitude values.

The user input unit 5200 may be a unit for a user to input data to control the mobile electronic device 5000. For example, the user input unit 5200 may include a keypad, a tome switch, a touch pad (a contact capacitance type, a pressure resistance film type, an infrared ray detecting type, a surface ultrasonic conducting type, an integral tension measuring type, or a piezo-effect type), a jog wheel, or a jog switch.

Also, the user input unit 5200 may include at least one module for receiving data from the user. For example, the user input unit 5200 may include a motion recognizing module 5210, a touch recognizing module 5220, and a voice recognizing module 5230.

The motion recognizing module 5210 recognizes movement of the mobile electronic device 5000, and may transmit information about the movement of the mobile electronic device 5000 to the control unit 5900.

The touch recognizing module 5220 may detect a touch gesture of the user on a touch screen, and transmit information about the touch gesture to the control unit 5900.

The voice recognizing module 5230 may recognize voice of the user by using a voice recognizing engine, and transmit the recognized voice to the control unit 5900.

The obtaining unit 5300 may obtain data from an external source. The obtaining unit 5300 may include an additional information obtainer 5310 and a content obtainer 5320.

When link information of additional information is received, the additional information obtainer 5310 may access a server based on the link information of the additional information and obtain the additional information.

When link information of content is received, the content obtainer 5320 may obtain the content from a server based on the link information of the content.

The output unit 5400 is used to output an audio signal, a video signal, or an alarm signal, and may include a display unit 5410 and an audio output module 5420.

The display unit 5410 may display information processed by the mobile electronic device 5000.

The display unit 5410 may include one of the DDI 120, 220, 320, 420, 520, 620, and 720 according to the embodiments of the present invention.

When the display unit 5410 and a touch pad form a layer structure that is configured as a touch screen, the display unit 5410 may be used as an input device as well as an output device. Also, at least two display units 5410 may exist according to a structure of the mobile electronic device 5000.

The audio output module 5420 may output audio data received from the communication unit 5100 or stored in the storage unit 5600 in a call signal receiving mode, a telephone mode, a recording mode, a voice recognizing mode, or a broadcast receiving mode.

The storage unit 5600 may store a program for processes and control performed by the control unit 5900. Also, the storage unit 5600 may perform a function of storing input/output data.

The storage unit 5600 may include at least one type of storage medium, such as a flash memory, a hard disk type memory, a multimedia card micro type memory, a card type memory (such as a secure digital (SD) or extreme digital (XD) memory), an RAM, an SRAM, a read-only memory (ROM), an electrically erasable programmable read-only memory (EEPROM), a programmable read-only memory (PROM), a magnetic memory, a magnetic disk, or an optical disk.

The interface unit 5700 may operate with any external device connected to the mobile electronic device 5000. For example, the interface unit 5700 may include a wired/wireless headset port, an external charger port, a wired/wireless data port, a memory card port, a port connecting a device including an identification module, an audio input/output (I/O) port, a video I/O port, or an earphone port.

The identification module is a chip storing various types of information for authorizing authority for use of the mobile electronic device 5000, and may include a user identify module (UIM), a subscriber identification module (SIM), or a universal subscriber identify module (USIM).

The power supply unit 5800 may supply power required to operate each component by receiving external power or internal power according to control of the control unit 5900.

The control unit 5900 may generally control overall operations of the mobile electronic device 5000. For example, the control unit 5900 may control the communication unit 5100, the user input unit 5200, the obtaining unit 5300, the output unit 5400, the storage unit 5600, the interface unit 5700, and the power supply unit 5800. The control unit 5900 may include one of the AP 110, 210, 310, 410, 510, 610, and 710 according to the embodiments of the present invention.

The mobile electronic device 5000 according to one or more embodiments of the present invention may use a relatively small amount of power for transferring data between the control unit 5900 and the display unit 5410.

FIG. 19 shows application examples of various electronic products including an electronic device 6000, according to embodiments of the present invention.

The electronic device 6000 according to one or more embodiments of the present invention may be employed in any one of various electronic products, such as a cell phone 6100, a TV 6200, an automated teller machine (ATM) 6300, an elevator 6400, a ticket machine 6500 used in subways or the like, a PMP 6600, an e-book 6700, and a navigation system 6800.

A DDI of the electronic device 6000 according to one or more embodiments of the present invention may drive a display panel in response to received downsized conversion data from an AP of a system. Thus, by using the electronic device 6000, power consumption of a processor may be reduced such that the processor is quickly driven on lower power, thereby improving the performance of an electronic product.

While one or more embodiments of the present invention have been described with reference to the figures, it will be understood by those of ordinary skill in the art that various changes in form and details may be made therein without departing from the spirit and scope of the present invention as defined by the following claims.

1. An electronic device comprising:
an application processor configured to generate conversion data by downsizing display data of each frame of according to display characteristic information of the each frame; and
a display driver configured to receive the conversion data and the display characteristic information and drive a display panel in response to the conversion data and the display characteristic information.

2. The electronic device of claim 1, wherein the display driver drives the display panel by upsizing the conversion data according to the display characteristic information.

3. The electronic device of claim 1, wherein the display characteristic information is a binary signal determined according to a compressible data capacity of the display data.

4. The electronic device of claim 1, wherein the downsizing is performed by compressing display data of a plurality of adjacent pixels to display data of one pixel.

5. The electronic device of claim 1, wherein the downsizing is performed by converting first sub-pixel pattern information corresponding to the display data to second sub-pixel pattern information.

6. The electronic device of claim 5, wherein the first sub-pixel pattern information is sub-pixel pattern information of a red, green, and blue (RGB) pattern, wherein three sub-pixels are included in one pixel, and the second sub-pixel pattern information is sub-pixel pattern information of a PenTile (RGBG) pattern, wherein two sub-pixels are included in one pixel.

7. The electronic device of claim 5, wherein the first sub-pixel pattern information is sub-pixel pattern information of an RGB pattern, wherein three sub-pixels are included in one pixel, and the second sub-pixel pattern information is sub-pixel pattern information of a YUV pattern, wherein three sub-pixels are included in one pixel.

8. The electronic device of claim 1, wherein the downsizing is performed by generating first compression display data by compressing display data of a plurality of adjacent pixels to display data of one pixel, and converting first sub-pixel pattern information corresponding to the first compression display data to second sub-pixel pattern information is sub-pixel pattern information of an RGB pattern, wherein three sub-pixels are included in one pixel, and the second sub-pixel pattern information is sub-pixel pattern information of a PenTile (RGBG) pattern, wherein two sub-pixels are included in one pixel.

10. The electronic device of claim 8, wherein the first sub-pixel pattern information is sub-pixel pattern information of an RGB pattern, wherein three sub-pixels are included in one pixel, and the second sub-pixel pattern information is sub-pixel pattern information of a YUV pattern, wherein three sub-pixels are included in one pixel.

11. The electronic device of claim 1, wherein the downsizing is performed by sampling only pixels in a first pixel group from among a plurality of pixel groups included in a pixel block comprising a plurality of pixels.

12. The electronic device of claim 11, wherein the plurality of pixel groups are divided into the first pixel group and a second pixel group, wherein the first pixel group comprises pixels connected to odd row lines and the second pixel group comprises pixels connected to even row lines.

13. The electronic device of claim 11, wherein the plurality of pixel groups are divided into the first pixel group and a second pixel group, wherein the first pixel group comprises pixels connected to odd column lines and the second pixel group comprises pixels connected to even column lines.

14. The electronic device of claim 11, wherein the plurality of pixel groups are divided into first through fourth pixel groups, wherein the first pixel group comprises pixels connected to odd row lines and odd column lines, the second pixel group comprises pixels connected to the odd row lines and even column lines, the third pixel group comprises pixels connected to even row lines and the odd column lines, and the fourth pixel group comprises pixels connected to the even row lines and the even column lines.

15. A communication device that comprises a display device, the communication device comprising:
an application processor configured to generate conversion data by downsizing display data of each frame according to display characteristic information of the each frame; and
a display driver configured to receive the conversion data and the display characteristic information and drive a display panel in response to received the conversion data and the display characteristic information.
